(19) United States
(12) Patent Application Publication
(10) Pub. No.: US 2012/0163279 A1
(43) Pub. Date: Jun. 28, 2012

(54) COMMUNICATION APPARATUS, COMMUNICATION TERMINAL APPARATUS, COMMUNICATION SYSTEM, AND COMMUNICATION METHOD

(76) Inventors: Xuan Mai Tran, Osaka (JP); Shinichi Tsuchida, Osaka (JP)

(21) Appl. No.: 13/394,464

(22) PCT Filed: Jul. 7, 2011
(86) PCT No.: PCT/JP2011/003890

§ 371 Date: Mar. 6, 2012

(30) Foreign Application Priority Data
Jul. 7, 2010 (JP) 2010-155277

(51) Int. Cl. H04W 72/04; H04W 4/06

(52) U.S. Cl. 370/312; 370/329

(57) ABSTRACT

A power-consumption-information collecting apparatus (1) that is a communication apparatus that transmits and receives data to and from power meters (2) with a device control function that are a plurality of communication terminal apparatuses includes: a management packet generation unit (100) that generates a management packet including terminal identification information that indicates a power meter with a device control function (2) permitted to transmit data in a predetermined period, and a priority index that indicates a priority of data to be transmitted in the predetermined period; a transmission unit (111) that transmits the management packet to the power meters (2) with a device control function; and a receiving unit (112) that receives data from a power meter (2) with a device control function determined based on the terminal identification information and the priority index, in the predetermined period.

### TECHNICAL FIELD

The present invention relates to communication apparatuses, communication terminal apparatuses, communication systems, and communication methods. In particular, the present invention relates to a communication apparatus, a communication terminal apparatus, a communication system, and a communication method for collecting power consumption of devices to perform overall control using wireless communication technology in a house.

### BACKGROUND ART

There are various multiplex systems as methods used to share a career in wireless communication. An example is 802.15.4, which is a standard for the small, low-power wireless network, and disclosed in Patent Literatures 1 and 2 and a Non-Patent Literature.

A wireless multiplex communication system used by communication apparatuses in Patent Literature 1 is now described using FIG. 37. In Patent Literature 1, a career (radio channel) is managed by a parent station which is a communication apparatus, and is divided into two periods, namely, a “concentrated control period” and a “collision period”, as shown in FIG. 37.

In the “concentrated control period”, the parent station realizes a communication period in which collisions of data transmitted from communication terminal apparatuses do not occur, by successively giving a data transmission right to communication terminal apparatuses based on the communication terminal apparatuses registered in a polling list.

On the other hand, in the “collision period”, a communication terminal apparatus that is not registered in the polling list requests the parent station to register the apparatus in the polling list using a carrier sense multiple access with collision avoidance (CSMA/CA) system, and is thereby allowed to communicate in the “concentrated control period”, which is a communication period in which no collisions occur. Furthermore, a communication terminal apparatus that communicates in the “concentrated control period” notifies the parent station of the transfer amount of data to be transmitted next, thereby improving efficiency of using the channel.

Next is a description of a configuration of a super frame for communication apparatuses in Non-Patent Literature 1, using FIG. 38. As shown in FIG. 38, a radio channel is equally divided into time slots with IEEE 802.15.4. The super frame configuration in Non-Patent Literature 1 includes a contention access period (CAP) and a contention free period (CFP) that are made up of a plurality of time slots.

In the CAP period, each communication terminal apparatus communicates using a slotted CSMA/CA system. Further, in the CFP period, only a communication terminal apparatus which has the right of using channel assigned by a parent station can transmit data.

Further, the parent station notifies the communication terminal apparatuses of the length of the CAP period, the length of the CFP period, and channel assignment information in the CFP period of the super frame, by transmitting beacons periodically. A communication terminal apparatus that does not have a transmission right in the CFP period can acquire the communication right in the CFP period, by requesting the parent station for channel reservation in the CAP period.

In this manner, in Patent Literature 1 and Non-Patent Literature 1, periods having the fixed length of the channel are set as a CAP and a CFP, thereby improving the efficiency of using the channel, and also enabling a specific communication terminal apparatus to be reliably given a period for communication.

On the other hand, the communication apparatus in Patent Literature 2 shown in FIG. 39 further improves efficiency of using a channel by setting shorter periods of the channel as a CAP and a CFP alternately, compared with Patent Literature 1 and Non-Patent Literature 1.

### CITATION LIST

### Patent Literature

[PTL 1] Japanese Unexamined Patent Application Publication No. 2004-158965
[PTL 2] Japanese Unexamined Patent Application Publication No. 2009-100389

### Non Patent Literature

[NPL 1] IEEE Std 802.15.4-2006, Wireless Medium Access Control (MAC) and Physical Layer (PHY) Specifications for Low-Rate Wireless Personal Area Networks (WPANs)

### SUMMARY OF INVENTION

### Technical Problem

However, the above conventional communication apparatuses have a problem that even when high priority data is generated in a communication terminal apparatus, unless the communication terminal apparatus is a communication terminal apparatus assigned to transmit data, the conventional communication apparatuses may not be able to receive the high priority data.

Specifically, in the concentrated control period in Patent Literature 1 and the CFP in Non-Patent Literature 1 (hereinafter, referred to as concentrated control period), only a communication terminal apparatus that is registered in a polling list or has channel assignment can transmit data. However, a communication terminal apparatus other than such an apparatus needs to wait until the collision period (hereinafter, referred to as contention period) or the CAP (hereinafter, referred to as a contention period) comes, and thus allowable delay of data may be exceeded, depending on an application. Furthermore, the priority of data that each communication terminal apparatus transmits is not taken into consideration at all, and accordingly, high priority data may not be transmitted with an allowable delay.

On the other hand, in the case of Patent Literature 2, a channel is divided into shorter fixed frames compared with Patent Literature 1 and Non-Patent Literature 1. In each frame, a polled communication terminal apparatus transmits data using the head period of the frame, and the period of the frame remaining after the polled communication terminal apparatus transmits data is used as a contention period. In Patent Literature 2, the length of each frame is shorter, compared with the concentrated control period in Patent Literature 1 and Non-Patent Literature 1, and thus, a delay in data transmission by a communication terminal apparatus that is not registered in the polling list or a communication terminal apparatus that does not have channel reservation is assumed to be reduced.

However, even in Patent Literature 2 as well as Patent Literature 1 and Non-Patent Literature 1, the priority of data transmitted by each communication terminal apparatus is not taken into consideration at all, and thus when high priority data is generated in a specific communication terminal apparatus, the high priority data may not be transmitted within the range of allowable delay.

As an example, a case is considered in which high priority data is generated in “Terminal A” that is a specific communication terminal apparatus, and Terminal A is not a communication terminal apparatus to be polled in the current frame. In this case, Terminal A transmits data using the CSMA period remaining after a polled communication terminal apparatus transmits data. However, in the CSMA period of the frame, a plurality of communication terminal apparatuses communicate in a contending manner, and thus Terminal A may not be able to transmit data with an allowable delay, depending on the number of contending communication terminal apparatuses.

The length of a CSMA period corresponds to the length of some packets, and when there is no communication terminal apparatus that communicates in the CSMA period, the CSMA period will not be used, and channel utilization efficiency will be decreased as a result, which is a problem.

The present invention is for solving the above conventional problems, and an object thereof is to provide a communication apparatus, a communication terminal apparatus, a communication system, and a communication method that enable, when high priority data is generated in another communication terminal apparatus, transmission and reception of information indicating the high priority data even if there is a communication terminal apparatus assigned to transmit data.

### Solution to Problem

In order to solve the above conventional problems, a communication apparatus according to an aspect of the present invention is a communication apparatus that transmits and receives data to and from a plurality of communication terminal apparatuses, the communication apparatus including: a management packet generation unit configured to generate a management packet including (i) terminal identification information indicating, among the communication terminal apparatuses, a communication terminal apparatus which is permitted to transmit data in a predetermined period, and (ii) a priority index indicating a priority of data permitted to be transmitted in the predetermined period; a transmission unit configured to transmit the generated management packet to the communication terminal apparatuses; and a receiving unit configured to receive data in the predetermined period from a communication terminal apparatus determined based on the terminal identification information and the priority index, from among the communication terminal apparatuses.

According to this, the communication apparatus transmits a management packet including terminal identification information and a priority index to the communication terminal apparatuses, and receives data from a communication terminal apparatus determined from the terminal identification information and the priority index. Here, data received by the communication apparatus is data with a priority for which transmission is permitted in the predetermined period, or information indicating data with the priority, such as a signal for identifying data with the priority. Specifically, the communication apparatus can receive information indicating data with the priority, not only from a communication terminal apparatus assigned to transmit data, but also from a communication terminal apparatus that holds data with a predetermined priority. Accordingly, even if there is a communication terminal apparatus assigned to transmit data, when high priority data is generated in another communication terminal apparatus, information indicating the high priority data can be received from the other communication terminal apparatus.

Preferably, the management packet generation unit includes a priority index management unit configured to store priority index management information in which at least one priority index indicating a priority of terminal data held by one of the communication terminal apparatuses and at least one short-term signal for identifying the terminal data are associated with each other, the receiving unit is configured to receive, when a first communication terminal apparatus indicated by the terminal identification information is permitted to transmit data in the predetermined period, and when a second communication terminal apparatus holds terminal data with a priority for which transmission in the predetermined period is permitted, a short-term signal for identifying the terminal data from the second communication terminal apparatus in a short-term period included in the predetermined period, the short-term period preceding a transmission period in which the first communication terminal apparatus transmits data, and the transmission unit is configured to transmit a control signal to a communication terminal apparatus that is a control target and determined from terminal data identified using a short-term signal.

According to this, the communication apparatus receives a short-term signal for identifying terminal data with a priority for which transmission is permitted in a predetermined period, from the second communication terminal apparatus in the short-term period preceding the transmission period in which data is transmitted from the first communication terminal apparatus, and transmits a control signal to a communication terminal apparatus that is a control target determined from terminal data identified using the short-term signal. Specifically, the communication apparatus can receive the short-term signal for identifying the high priority terminal data from the second communication terminal apparatus in the short-term period preceding the transmission period in which data is transmitted from the first communication terminal apparatus. Accordingly, the communication apparatus can receive the short-term signal, without affecting transmission of data in the transmission period. Accordingly, even if there is a communication terminal apparatus assigned to transmit data, when high priority data is generated in another communication terminal apparatus, the communication apparatus can receive a signal for identifying the high priority data.

Preferably, the priority index management unit is configured to store the priority index management information in which information indicating at least one of the communication terminal apparatuses that holds terminal data is further associated with the at least one priority index and the at least one short-term signal, the management packet generation unit is configured to permit, with reference to the priority index management information, the second communication terminal apparatus to transmit data in a later period succeeding the predetermined period when the receiving unit receives a short-term signal, the second communication terminal apparatus being a communication terminal apparatus associated with the short-term signal, the receiving unit is configured to receive terminal data identified using the short-term signal from the second communication terminal apparatus in the later period, and the transmission unit is configured to transmit the control signal to a communication terminal apparatus that is a control target and determined from terminal data received by the receiving unit.

According to this, when a short-term signal is received, the communication apparatus permits the second communication terminal apparatus associated with the short-term signal to transmit data in a later period succeeding the predetermined period, and receives terminal data identified using the short-term signal, from the second communication terminal apparatus in the later period. Specifically, after receiving a short-term signal, the communication apparatus can receive high priority terminal data identified using the short-term signal.

Preferably, the priority index management unit is configured to store the priority index management information in which the terminal data is further associated with the at least one priority index and the at least one short-term signal, and the transmission unit is configured to transmit the priority index management information to the communication terminal apparatuses, and transmit, when the receiving unit receives a short-term signal, the control signal to a communication terminal apparatus that is a control target and determined from terminal data associated with the short-term signal, with reference to the priority index management information.

According to this, the communication apparatus transmits the priority index management information to the communication terminal apparatuses, and also transmits, when a short-term signal is received, a control signal to a communication terminal apparatus that is a control target determined from terminal data associated with the short-term signal, with reference to the priority index management information. Specifically, the communication terminal apparatuses receive the priority index management information transmitted by the communication apparatus, and transmit a short-term signal associated with high priority terminal data to the communication apparatus, with reference to the received priority index management information. Accordingly, the communication apparatus can obtain terminal data associated with the received short-term signal, with reference to the priority index management information.

Preferably, the priority index management unit is configured to calculate the priority index by subtracting, from a lowest priority index that is a greatest priority index number and indicates a lowest priority, a value obtained by multiplying, by a predetermined coefficient, an amount of change in power consumed when a device controlled by one of the communication terminal apparatuses performs an operation indicated by terminal data.

According to this, the communication apparatus calculates a priority index by subtracting, from the lowest priority index, a value obtained by multiplying, by a predetermined coefficient, the power change amount of a device controlled by the communication terminal apparatus. Specifically, a priority index is calculated such that the greater the power change amount of the device is, the higher the priority is. Accordingly, the communication apparatus can preferentially obtain operation information of a device whose power consumption greatly changes, as information for adjusting power consumption.

Preferably, the receiving unit is configured to receive data from the first communication terminal apparatus in the predetermined period, after receiving the short-term signal from the second communication terminal apparatus in the short-term period.

According to this, the communication apparatus receives data from the first communication terminal apparatus in the predetermined period, after receiving a short-term signal from the second communication terminal apparatus in the short-term period. Specifically, the communication apparatus can receive a short-term signal for identifying high priority data from the second communication terminal apparatus, and can receive data permitted to be transmitted in the predetermined period, from the first communication terminal apparatus. Accordingly, when there is a first communication terminal apparatus assigned to transmit data, and when high priority data is generated in a second communication terminal apparatus, the communication apparatus can receive information that indicates the high priority data from the second communication terminal apparatus, and can furthermore receive data also from the first communication terminal apparatus.

Preferably, the receiving unit is configured to detect a collision of short-term signals transmitted from the communication terminal apparatuses, and the management packet generation unit is configured to obtain a collision priority index that is a priority index of the short-term signals that have collided, and generate a management packet for a period after the detection of the collision, the management packet including the obtained collision priority index as a priority index included in the management packet for the period after the detection of the collision.

According to this, the communication apparatus detects a collision of short-term signals transmitted from the communication terminal apparatuses, and generates a management packet that includes the priority index of the short-term signals that have collided, as the priority index included in the management packet for the period after the detection of the collision. Specifically, since the communication apparatus cannot receive the short-term signals that have collided, the communication apparatus generates, after the collision, a management packet including the priority index of the short-term signals that have collided, in order to receive the short-term signals again. Accordingly, even when high priority data is generated in communication terminal apparatuses, and a collision occurs when short-term signals for identifying the data are to be received, the short-term signals for identifying the high priority data that has collided can be received.

Preferably, when a first communication terminal apparatus indicated by the terminal identification information and a second communication terminal apparatus that holds data with a priority indicated by the priority index are permitted to transmit data in the predetermined period, the receiving unit is configured to receive data from the second communication terminal apparatus.

According to this, the communication apparatus preferentially receives data from a communication terminal apparatus that holds data with a priority indicated by a priority index, rather from a communication terminal apparatus indicated by terminal identification information. Specifically, the communication apparatus receives data from the communication terminal apparatus that holds data with the predetermined priority, instead from the communication terminal apparatus assigned to transmit data. Accordingly, even if there is a communication terminal apparatus assigned to transmit data, when high priority data is generated in another communication terminal apparatus, the high priority data can be received from the other communication terminal apparatus.

Preferably, the receiving unit is configured to detect a collision of data pieces transmitted from the communication terminal apparatuses, and the management packet generation unit is configured to obtain a collision priority index that is a priority index of the data pieces that have collided, and generate a management packet for a period after the detection of the collision, the management packet including the obtained collision priority index as a priority index included in the management packet for the period after the detection of the collision.

According to this, the communication apparatus detects a collision of data transmitted from communication terminal apparatuses, and generates a management packet that includes the priority index of the data that has collided, as the priority index included in the management packet for the period after the detection of the collision. Specifically, since the communication apparatus cannot receive data that has collided, the communication apparatus generates, after the collision, a management packet including the priority index of the data that has collided, in order to receive the data again. Accordingly, even when high priority data is generated in communication terminal apparatuses, and a collision occurs when the data is to be received, the high priority data that has collided can be received.

Preferably, when the collision priority index is not a highest priority index indicating a highest priority, the management packet generation unit is configured to generate the management packet for the period after the detection of the collision such that the highest priority index to the collision priority index are repeated as the priority index included in the management packet for the period after the detection of the collision.

According to this, after the occurrence of a collision of data pieces, the communication apparatus generates a management packet such that the highest priority index to a collision priority index are repeated, as the priority index included in a management packet. Specifically, when there is data with a priority higher than the priority of the data that has collided, the higher priority data can be preferentially received. Accordingly, when data with a priority higher than the priority of the data that has collided is generated in a communication terminal apparatus, the higher priority data can be received.

Preferably, the management packet generation unit is configured to generate a management packet including terminal identification information pieces and priority indexes that respectively correspond to two or more periods.

According to this, the communication apparatus generates a management packet including terminal identification information pieces and priority indexes respectively corresponding to two or more periods. Accordingly, the terminal identification information pieces and the priority indexes corresponding to a plurality of predetermined periods can be included in the management packet, and thus data to be received can be set with ease.

Preferably, the receiving unit is configured to receive, as data indicating a state of a device controlled by one of the communication terminal apparatuses, data including at least one of power consumption data, an amount of stored hot water, an amount of power generation, remaining battery power, and an operation mode of the device, and the management packet generation unit is configured to determine a priority index according to the state of the device indicated by the data received by the receiving unit, and generate a management packet including the determined priority index.

According to this, the communication apparatus determines a priority index according to the state of a device controlled by a communication terminal apparatus, and generates a management packet including the determined priority index. Specifically, a priority index is changed according to the state of a device controlled by a communication terminal apparatus by determining a specific priority index when the device is in a specific state, for instance. Accordingly, data obtained in the case where a device controlled by a communication terminal apparatus is in a specific state can be preferentially received from the communication terminal apparatus.

Further, in order to solve the above conventional problems, a communication terminal apparatus according to an aspect of the present invention is a communication terminal apparatus that transmits and receives data to and from a communication apparatus, the communication terminal apparatus including: a receiving unit configured to receive, from the communication apparatus, a management packet including (i) terminal identification information indicating a communication terminal apparatus which is permitted to transmit data in a predetermined period, and (ii) a priority index indicating a priority of data permitted to be transmitted in the predetermined period; a judgment unit configured to judge from the terminal identification information and the priority index included in the received management packet, whether or not the communication terminal apparatus has obtained permission to transmit data; and a transmission unit configured to transmit data in the predetermined period, when the judgment unit judges that the communication terminal apparatus has obtained permission to transmit the data.

According to this, the communication terminal apparatus judges whether or not the apparatus itself has obtained permission to transmit data, from the terminal identification information and the priority index that are included in the received management packet, and transmits the data in a predetermined period. Specifically, when the communication terminal apparatus is a communication terminal apparatus assigned to transmit data or a communication terminal apparatus holding data with a predetermined priority, the communication terminal apparatus can transmit data. Accordingly, even in the case where the communication terminal apparatus is not a communication terminal apparatus assigned to transmit data, when high priority data is generated, the communication terminal apparatus can transmit the high priority data.

Preferably, the judgment unit is configured to compare the priority index included in the management packet received by the receiving unit with a priority index of data that the communication terminal apparatus is to transmit, and judge that the communication terminal apparatus has obtained permission to transmit data, when a priority indicated by the priority index of the data that the communication terminal apparatus is to transmit is higher than or equal to a priority indicated by the priority index included in the management packet, and the transmission unit is configured to transmit a short-term signal for identifying terminal data that is the data with the priority indicated by the priority index to the communication apparatus, when the judgment unit judges that the communication terminal apparatus has obtained permission to transmit data.

According to this, when the priority indicated by the priority index of data that the apparatus itself is to transmit is greater than or equal to the priority indicated by the priority index included in the management packet, the communication terminal apparatus judges that the apparatus itself has obtained permission to transmit data, and transmits a short-term signal for identifying the data. Accordingly, when high priority data is generated in the apparatus itself, the communication terminal apparatus can transmit a short-term signal for identifying the high priority data, even in the case where there is another communication terminal apparatus assigned to transmit data.

Preferably, the communication terminal apparatus further includes a priority index information holding unit configured to store priority index management information in which the terminal data, the priority index indicating the priority of the terminal data, and the short-term signal for identifying the terminal data are associated with one another, wherein the receiving unit is configured to receive the priority index management information from the communication apparatus, and cause the priority index information holding unit to store the received priority index management information, and the transmission unit is configured to transmit the short-term signal associated with the terminal data to the communication apparatus, with reference to the priority index management information.

According to this, the communication terminal apparatus receives priority index management information from the communication apparatus, and transmits a short-term signal associated with the terminal data to the communication apparatus, with reference to the received priority index management information. Specifically, the communication terminal apparatus can obtain a short-term signal associated with high priority terminal data, with reference to the priority index management information received from the communication apparatus, and thus can transmit the short-term signal associated with the terminal data to the communication apparatus.

Preferably, the judgment unit is configured to judge whether or not the communication terminal apparatus has obtained permission to transmit data, by comparing the terminal identification information included in the management packet received by the receiving unit with terminal identification information of the communication terminal apparatus, and when the judgment unit judges that the communication terminal apparatus has obtained permission to transmit the data, the transmission unit is configured to (i) judge, before transmitting data, whether or not data is being transmitted from another communication terminal apparatus to the communication apparatus, (ii) avoid transmitting data when judging that data is being transmitted from the other communication terminal apparatus, and (iii) transmit data when judging that data is not being transmitted from the other communication terminal apparatus.

According to this, the communication terminal apparatus judges whether or not the apparatus itself has obtained permission to transmit data from the terminal identification information included in the management packet, and also judges, before transmitting data, whether or not data is being transmitted from another communication terminal apparatus to the communication apparatus, and dose not transmit data when judging that data is being transmitted from the other communication terminal apparatus. Specifically, even in the case where the apparatus itself is a communication terminal apparatus assigned to transmit data, when data is being transmitted from another communication terminal apparatus to the communication apparatus, the communication terminal apparatus does not transmit data. Accordingly, even if the apparatus itself is a communication terminal apparatus assigned to transmit data, when high priority data is generated in another communication terminal apparatus, the other communication terminal apparatus can be caused to preferentially transmit the high priority data.

Preferably, the judgment unit is configured to compare the priority index included in the management packet received by the receiving unit with a priority index of data that the communication terminal apparatus is to transmit, and judge that the communication terminal apparatus has obtained permission to transmit data, when a priority indicated by the priority index of the data that the communication terminal apparatus is to transmit is higher than or equal to a priority indicated by the priority index included in the management packet, and the transmission unit is configured to transmit data, when the judgment unit judges that the communication terminal apparatus has obtained permission to transmit the data.

According to this, the priority indicated by the priority index of data that the apparatus itself is to transmit is greater than or equal to the priority indicated by the priority index included in the management packet, the communication terminal apparatus judges that the apparatus itself has obtained permission to transmit data, and transmits the data. Accordingly, even if there is another communication terminal apparatus assigned to transmit data, when high priority data is generated in the apparatus itself, the apparatus itself can be transmit the high priority data.

Preferably, the judgment unit is configured to judge whether or not the communication terminal apparatus has obtained permission to transmit data, as a result of determination of a priority index of data to be transmitted to the communication apparatus according to a state of a device controlled by the communication terminal apparatus, the state being indicated by data including at least one of power consumption data, an amount of stored hot water, an amount of power generation, remaining battery power, and an operation mode of the device.

According to this, the communication terminal apparatus judges whether or not the apparatus itself has obtained permission to transmit data, as a result of determination of a priority index of data to be transmitted to the communication apparatus according to the state of the device controlled by the apparatus itself. Specifically, a priority index is changed according to the state of a device controlled by the communication terminal apparatus, by determining a specific priority index when the device is in a specific state, for instance. Accordingly, data obtained in the case where the device controlled by the communication terminal apparatus is in a specific state can be preferentially transmitted to the communication apparatus.

The present invention can be realized not only as such a communication apparatus or a communication terminal apparatus but also as a communication system including the communication apparatus and the communication terminal apparatus. Further, the present invention can be realized as an integrated circuit including processing units that constitute the communication apparatus or the communication terminal apparatus, or as a method including the processing performed by the processing units as steps. Furthermore, the present invention can be realized as a program that causes a computer to execute these steps, a computer-readable recording medium, such as CD-ROM, on which the program is recorded, or information, data, or a signal that indicates the program. Such program, information, data, and a signal may be distributed via a communication network such as the Internet.

### Advantageous Effects of Invention

According to a communication apparatus, a communication terminal apparatus, a communication system, and a communication method according to the present invention, when high priority data is generated in a specific communication terminal apparatus, the generated high priority data can be preferentially transmitted and received, even if there is a communication terminal apparatus assigned to transmit data.

### BRIEF DESCRIPTION OF DRAWINGS

FIG. 1 shows a configuration of a power-consumption collecting system in Embodiment 1 of the present invention.

FIG. 2 shows a configuration of a power-consumption-information collecting apparatus in Embodiment 1 of the present invention.

FIG. 3 shows a configuration of a management packet generation unit in Embodiment 1 of the present invention.

FIG. 4 shows a configuration of a power meter with a device control function in Embodiment 1 of the present invention.

FIG. 5 shows a configuration of a judgment unit in Embodiment 1 of the present invention.

FIG. 6 shows a configuration of a transmission unit of a communication processing unit in Embodiment 1 of the present invention.

FIG. 7 shows a configuration of a transmission control unit in Embodiment 1 of the present invention.

FIG. 8 shows a frame structure of a wireless communication system in Embodiment 1 of the present invention.

FIG. 9 is a flowchart showing an example of processing performed by the power-consumption-information collecting apparatus in Embodiment 1 of the present invention.

FIG. 10 is a flowchart for describing a transmission period judgment algorithm performed by the power meter with a device control function in Embodiment 1 of the present invention.

FIG. 11 is a flowchart for describing an algorithm for interrupt transmission in a concentrated control period performed by the power meter with a device control function in Embodiment 1 of the present invention.

FIG. 12 is a flowchart for describing an algorithm for transmission in the concentrated control period performed by the power meter with a device control function in Embodiment 1 of the present invention.

FIG. 13 illustrates Scenario 1 executed by the power-consumption collecting system in Embodiment 1 of the present invention.

FIG. 14 illustrates Scenario 2 executed by the power-consumption collecting system in Embodiment 1 of the present invention.

FIG. 15 shows a frame structure of a wireless communication system in Embodiment 2 of the present invention.

FIG. 16 is a flowchart for describing a transmission period judgment algorithm performed by a power meter with a device control function in Embodiment 2 of the present invention.

FIG. 17 is a flowchart for describing an algorithm for interrupt transmission in the concentrated control period performed by the power meter with a device control function in Embodiment 2 of the present invention.

FIG. 18 is a flowchart for describing an algorithm for transmission in the concentrated control period performed by the power meter with a device control function in Embodiment 2 of the present invention.

FIG. 19 illustrates a scenario executed by a power-consumption collecting system in Embodiment 2 of the present invention.

FIG. 20 shows a configuration of a management packet generation unit in Embodiment 3 of the present invention.

FIG. 21 shows a configuration of a transmission control unit in Embodiment 3 of the present invention.

FIG. 22 shows an example of a priority index management table in Embodiment 3 of the present invention.

FIG. 23 shows a frame structure of a wireless communication system in Embodiment 3 of the present invention.

FIG. 24 is a flowchart showing an example of processing performed by a power-consumption-information collecting apparatus in Embodiment 3 of the present invention.

FIG. 25 is a flowchart showing an example of collision avoidance processing performed by the power-consumption-information collecting apparatus in Embodiment 3 of the present invention.

FIG. 26 is a flowchart for describing an algorithm for interrupt transmission in the concentrated control period performed by a power meter with a device control function in Embodiment 3 of the present invention.

FIG. 27 illustrates Scenario 1 executed by a power-consumption collecting system in Embodiment 3 of the present invention.

FIG. 28 illustrates Scenario 2 executed by the power-consumption collecting system in Embodiment 3 of the present invention.

FIG. 29 illustrates Scenario 3 executed by the power-consumption collecting system in Embodiment 3 of the present invention.

FIG. 30 illustrates Scenario 4 executed by the power-consumption collecting system in Embodiment 3 of the present invention.

FIG. 31 illustrates Scenario 4 executed by the power-consumption collecting system in Embodiment 3 of the present invention.

FIG. 32 shows a frame structure of a wireless communication system in Embodiment 4 of the present invention.

FIG. 33 is a flowchart for describing an algorithm for interrupt transmission in the concentrated control period performed by a power meter with a device control function in Embodiment 4 of the present invention.

FIG. 34 illustrates a scenario executed by a power-consumption collecting system in Embodiment 4 of the present invention.

FIG. 35 shows power consumption of a plurality of home appliances.

FIG. 36 shows power consumption of a cleaner.

FIG. 37 shows a frame structure for communication apparatuses in Patent Literature 1.

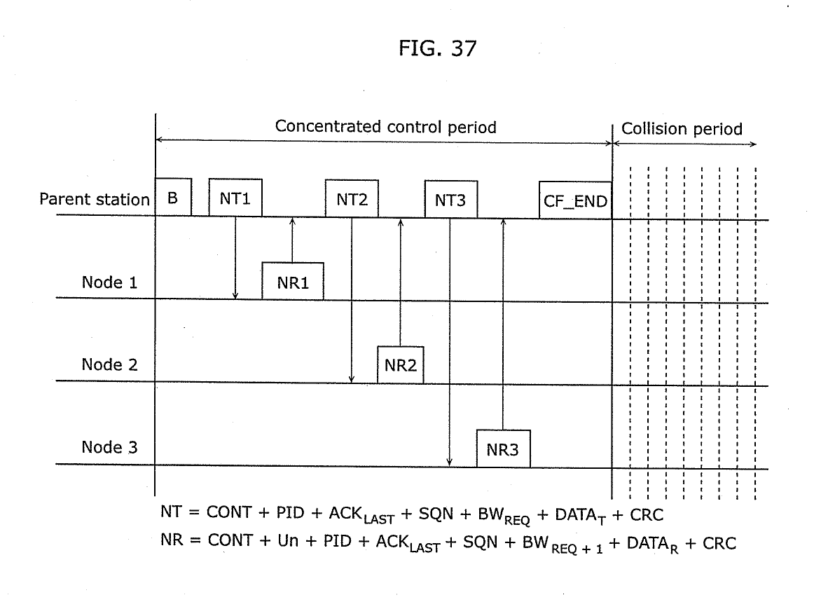

FIG. 38 shows a frame structure for communication apparatuses in Non-Patent Literature 1.

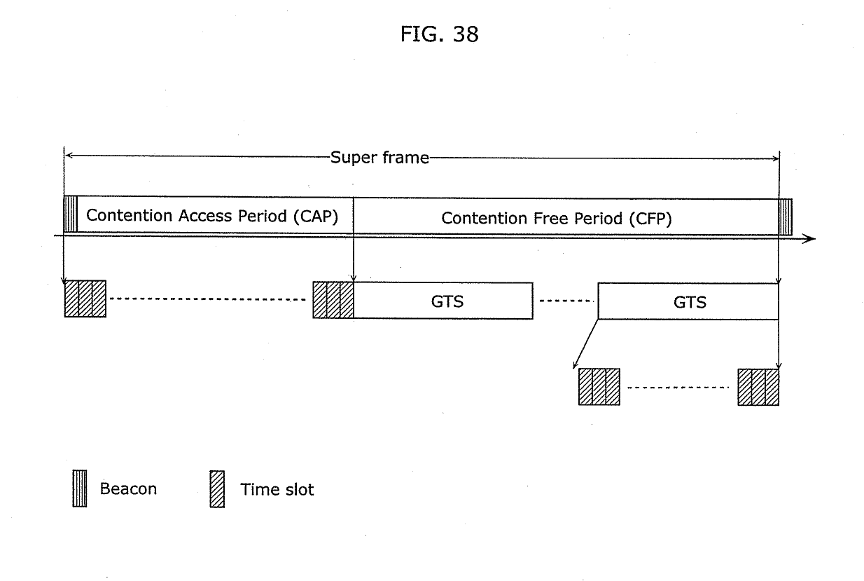

FIG. 39 shows a frame structure for communication apparatuses in Patent Literature 2.

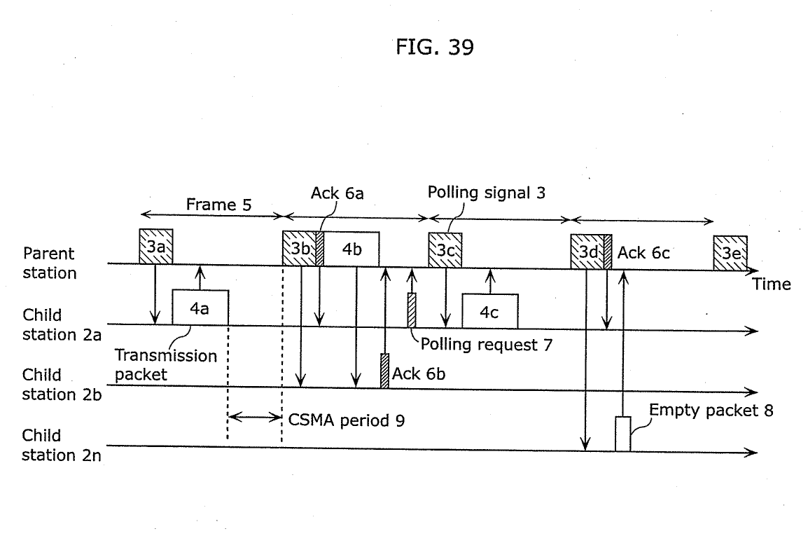

### DESCRIPTION OF EMBODIMENTS

The following is a description of embodiments of the present invention, with reference to the drawings.

### Embodiment 1

In Embodiment 1 of the present invention, a system is considered in which a power-consumption-information collecting apparatus 1 that is a communication apparatus collects power consumption of devices in a building that consume power using wireless communication via power meters 2 with a device control function that are communication terminal apparatuses, and controls the devices that consume power such that total power consumption of all the devices that consume power does not exceed a determined limit value.

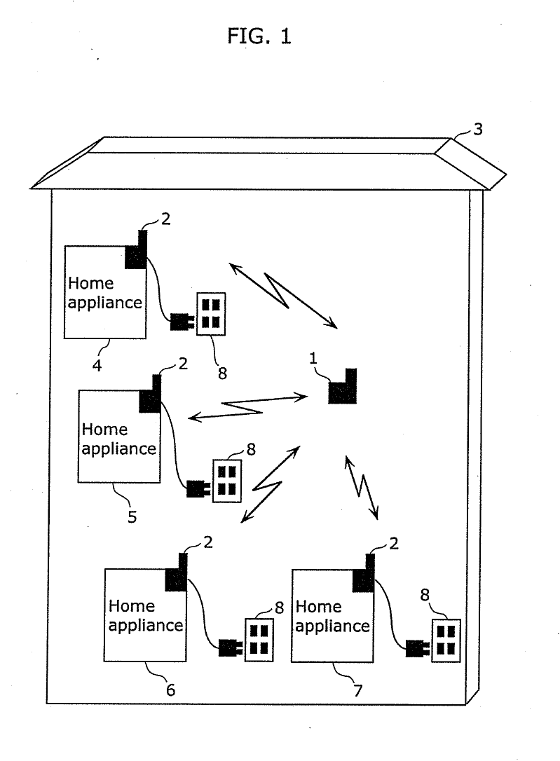

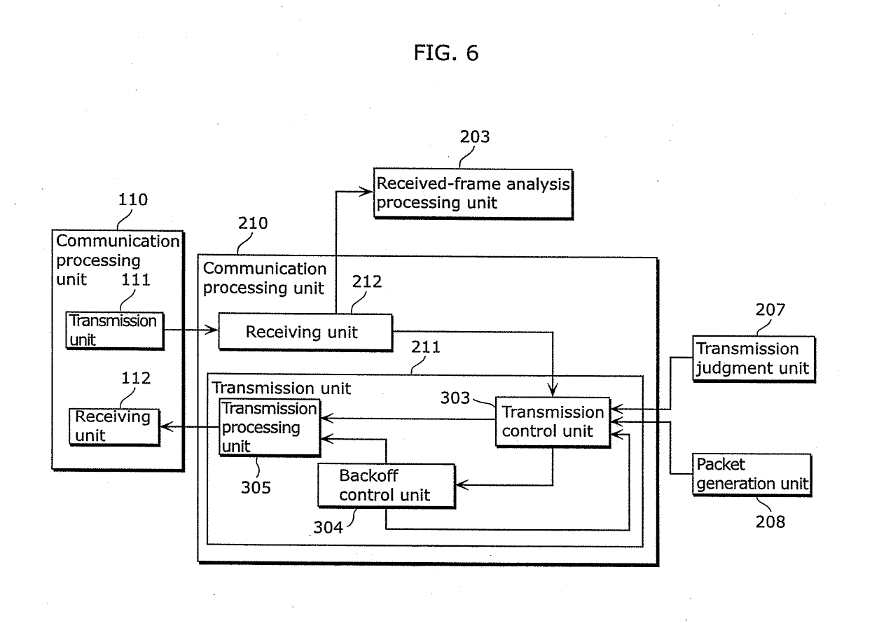

FIG. 1 shows a configuration of a power-consumption collecting system in Embodiment 1 of the present invention. It should be noted that devices that consume power are home appliances in the description of FIG. 6 and the following drawings, for simplicity.

FIG. 1 shows an example of a relationship among the power-consumption-information collecting apparatus 1, home appliances 4 to 7 that use power supplied via electrical outlets 8, and the power meters 2 with a device control function connected to the home appliances 4 to 7, which are provided in a building 3 according to the present embodiment.

In FIG. 1, the power meters 2 with a device control function can be connected to the home appliances 4 to 7 using a serial interface cable such as a universal serial bus (USB), for example, or can also be provided in the home appliances 4 to 7.

Here, specific examples of the home appliances 4 to 7 that are power measurement targets include an electric pot, an air-conditioner, a television, a microwave oven, an electric cleaner, and the like.

All the home appliances 4 to 7 are “network-connected home appliances” in conformity with a wireless local area network (LAN) standard such as, for example, 802.15.4 (ZigBee), and ON/OFF of the power, setting and adjustment of various operating states, and the like can be remotely controlled by a home controller, for example. In the following, it is assumed that the home appliances 4 to 7 and the power-consumption-information collecting apparatus 1 communicate with each other in accordance with the wireless LAN standard 802.15.4.

It should be noted that the power-consumption-information collecting apparatus 1 corresponds to a “communication apparatus” described in the claims, and the power meters 2 with a device control function correspond to “communication terminal apparatuses” described in the claims. Further, the power-consumption collecting system including the power-consumption-information collecting apparatus 1 and the power meters 2 with a device control function correspond to a “communication system” described in the claims.

Next is a description of the configuration of the power-consumption-information collecting apparatus 1 in Embodiment 1 of the present invention.

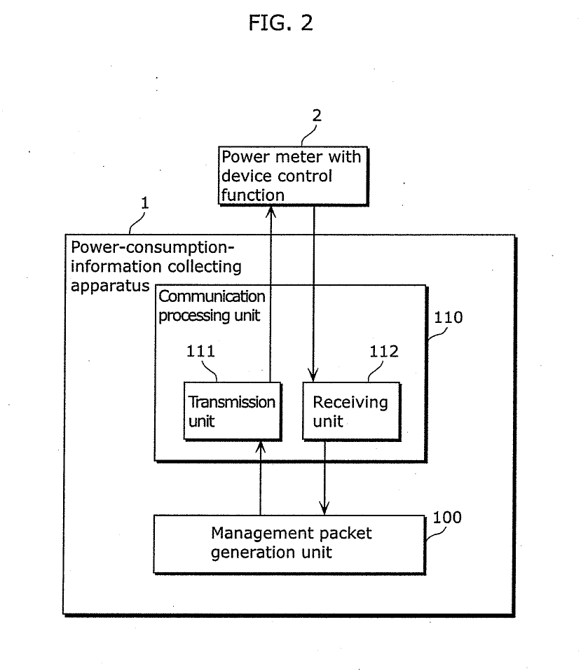

FIG. 2 shows the configuration of the power-consumption-information collecting apparatus 1 in Embodiment 1 of the present invention.

As shown in FIG. 2, the power-consumption-information collecting apparatus 1 includes a management packet generation unit 100 and a communication processing unit 110. Further, the communication processing unit 110 includes a transmission unit 111 and a receiving unit 112.

The management packet generation unit 100 generates a management packet including terminal identification information indicating a power meter 2 with a device control function permitted to transmit data in a predetermined period among the power meters 2 with a device control function that are a plurality of communication terminal apparatuses, and a priority index that indicates a priority of data permitted to be transmitted in the predetermined period. It should be noted that the management packet generation unit 100 may generate a management packet for each period, or may generate a management packet including terminal identification information pieces and priority indexes respectively corresponding to two or more periods.

Further, the management packet generation unit 100 determines a priority index according to the state of a device controlled by the power meter 2 with a device control function, which is indicated by the data received by the receiving unit 112 of the communication processing unit 110, and generates a management packet including the determined priority index. It should be noted that the management packet generation unit 100 will be described in detail below.

The communication processing unit 110 communicates with the power meters 2 with a device control function, to transmit data to the power meters 2 with a device control function, and also to receive, from the power meters 2 with a device control function, data indicating the states of target devices whose power consumption data is collected, such as the home appliances 4 to 7, packet collision information, and the like. Here, the transmission unit 111 and the receiving unit 112 included in the communication processing unit 110 will be described.

The transmission unit 111 transmits a management packet generated by the management packet generation unit 100 to the power meters 2 with a device control function.

The receiving unit 112 receives data in the predetermined period from a power meter 2 with a device control function determined based on the terminal identification information and the priority index, from among the power meters 2 with a device control function. Specifically, when a first communication terminal apparatus indicated by the terminal identification information, and a second communication terminal apparatus that holds data with a priority indicated by the priority index are permitted to transmit data in the predetermined period, the receiving unit 112 receives data from the second communication terminal apparatus.

Thus, even if there is a power meter 2 with a device control function assigned to transmit data, the receiving unit 112 preferentially receives high priority data from the power meter 2 with a device control function that holds the high priority data.

Here, as data indicating the state of a device controlled by one of the power meters 2 with a device control function, the receiving unit 112 receives data including at least one of power consumption data, the amount of stored hot water, the amount of power generation, remaining battery power, and an operation mode of the device. Furthermore, the receiving unit 112 detects a collision of data pieces transmitted from the power meters 2 with a device control function.

Next is a description of a detailed configuration of the management packet generation unit 100.

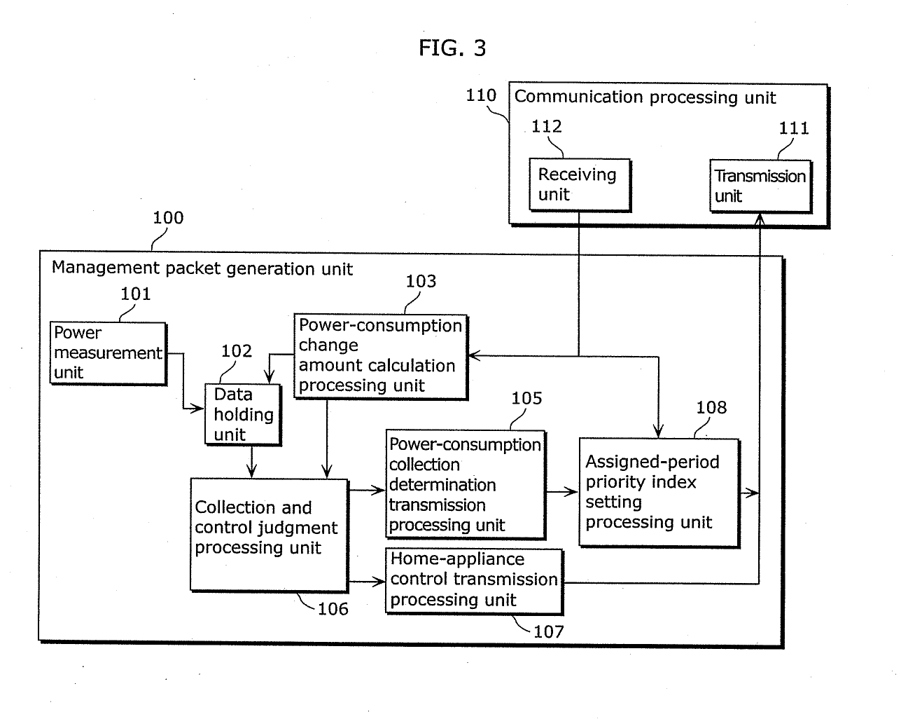

FIG. 3 shows a configuration of the management packet generation unit 100 in Embodiment 1 of the present invention.

As shown in FIG. 3, the management packet generation unit 100 includes a power measurement unit 101, a data holding unit 102, a power-consumption change amount calculation processing unit 103, a power-consumption collection determination transmission processing unit 105, a collection and control judgment processing unit 106, a home-appliance control transmission processing unit 107, and an assigned-period priority index setting processing unit 108.

The power measurement unit 101 measures and obtains power consumption values of target devices whose power consumption data is collected such as the home appliances 4 to 7, from a distribution board, for instance.

The power-consumption change amount calculation processing unit 103 calculates a power change amount, which is the amount of change in power consumption value of each target device whose power consumption data is collected, from data obtained via the receiving unit 112 of the communication processing unit 110.

The data holding unit 102 is a memory storing power consumption values obtained by the power measurement unit 101, and power change amounts calculated by the power-consumption change amount calculation processing unit 103.

The collection and control judgment processing unit 106 obtains a power consumption value and a power change amount from the data holding unit 102, and judges whether it is necessary to change a target device whose power consumption data is collected and control a home appliance. It should be noted that the collection and control judgment processing unit 106 can also directly obtain the power change amount from the power-consumption change amount calculation processing unit 103.

Based on the power change amount of a home appliance whose power consumption can be suppressed, the home-appliance control transmission processing unit 107 selects, if necessary, a home appliance whose operating state is to be changed, and transmits a control instruction to the power meter 2 with a device control function of the home appliance selected as the control target via the transmission unit 111 of the communication processing unit 110. Note that the selection of a home appliance to be controlled here may be controlled using not only the power change amount, but also a frequency in use based on the operating time, a parameter according to a priority given by presetting, and the like.

Further, the home-appliance control transmission processing unit 107 has a function of dynamically designating, for each home appliance, a priority for collecting information therefrom necessary to control the home appliance. For example, when a home appliance that is not operating and whose power consumption is high transmits terminal start report data to the power-consumption-information collecting apparatus 1 at the starting, the home-appliance control transmission processing unit 107 designates a high priority index to be set for the home appliance. Alternatively, the home-appliance control transmission processing unit 107 designates a high priority index to be set, when a home appliance transmits at least data as will be described below.

Specifically, such data is data notified when the amount of hot water of a hot-water storage tank of a fuel cell reached a specific level, data notified when the amount of power generation of a solar cell has fell to a specific level, data notified when the remaining storage battery power has reached a specific level, data notified when the amount of hot water of a hot-water storage tank of a natural refrigerant heat pump water heater has reached a specific level, data notified when the amount of power generation of a fuel cell has reached a specific level, or data notified when a home appliance shifts from a low power consumption operation mode to a high power consumption operation mode, such as data notified when, for example, a dishwasher or a washing and drying machine shifts to a washing mode or a drying mode.

It should be noted that the home-appliance control transmission processing unit 107 may dynamically designate a specific priority for specific data of a specific home appliance, rather than a fixed value for a priority index of each data piece.

The power-consumption collection determination transmission processing unit 105 determines in which of a contention period and a concentrated control period, power consumption data is to be collected, based on the amount of power consumed by each target device whose power consumption data is to be collected, the amount being determined by the collection and control judgment processing unit 106.

The assigned-period priority index setting processing unit 108 determines, for each guaranteed time slot (GTS), “an ID of a device assigned to the GTS, and the position of a start time slot of the GTS, and the length of the GTS”, as information of assignment in the concentrated control period for a target device from which data is to be collected in the concentrated control period, which is determined by the power-consumption collection determination transmission processing unit 105. Specifically, an ID of a device assigned to each GTS is terminal identification information that indicates a power meter 2 with a device control function permitted to transmit data in the GTS, among the power meters 2 with a device control function provided in a plurality of home appliances.

Furthermore, the assigned-period priority index setting processing unit 108 sets, for each GTS, a priority index for which interruption is allowed, using packet collision information obtained by the communication processing unit 110. It should be noted that the assigned-period priority index setting processing unit 108 sets the priority index for which interruption is allowed, such that the higher, the priority of data is, the smaller, the priority index number is.

Here, in the setting of a priority index for which interruption is allowed for each GTS, the assigned-period priority index setting processing unit 108 can set the same priority index for a plurality of GTSs in a continuous or periodical manner, in order to allow high priority data to be preferentially transmitted, for example.

Further, the assigned-period priority index setting processing unit 108 can specify, from “a GTS in which a collision of packets has occurred”, which is packet collision information obtained by the receiving unit 112 of the communication processing unit 110, the collision priority index that is a priority index of the packets that have collided, and can set the same priority index as the specified collision priority index for a plurality of GTSs in a continuous or periodical manner, so as to increase the rate at which a packet with a priority index as that of the packets that have collided is successfully transmitted.

According to this configuration, the assigned-period priority index setting processing unit 108 dynamically sets the priority index for which interruption is allowed of each GTS in the concentrated control period, thereby allowing high priority data to obtain a right to be transmitted. Further, the assigned-period priority index setting processing unit 108 can decrease the collision rate of interrupt packets by setting a priority index for which interruption is allowed of each GTS, utilizing interrupt packet collision information.

Then, the assigned-period priority index setting processing unit 108 generates a management packet including terminal identification information indicating a power meter 2 with a device control function of a home appliance that is assigned to each GTS, and a priority index for which interruption is allowed for each GTS, and sends the generated packet to the transmission unit 111.

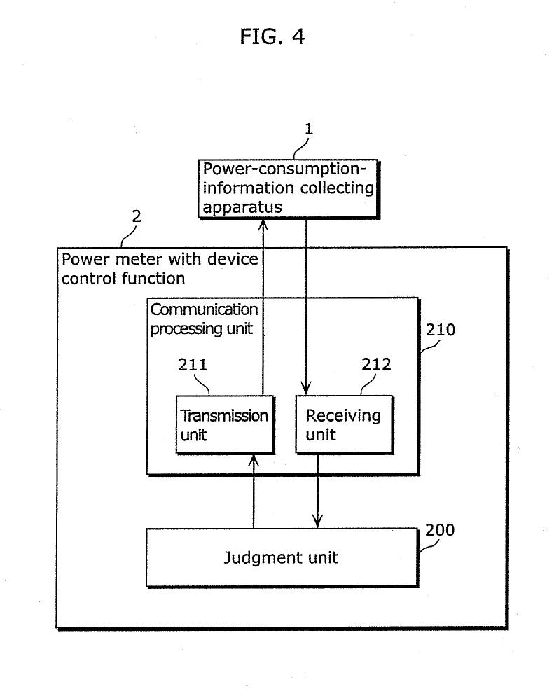

FIG. 4 shows the configuration of the power meters 2 with a device control function in Embodiment 1 of the present invention.

As shown in FIG. 4, each of the power meters 2 with a device control function includes a judgment unit 200 and a communication processing unit 210. Further, the communication processing unit 210 includes a transmission unit 211 and a receiving unit 212.

The judgment unit 200 judges whether or not the meter itself has obtained permission to transmit data, from terminal identification information and a priority index that are included in a management packet received by the receiving unit 212 of the communication processing unit 210.

Specifically, the judgment unit 200 judges whether or not the meter itself has obtained permission to transmit data by comparing the terminal identification information included in the management packet with terminal identification information of the meter itself.

Further, the judgment unit 200 compares the priority index included in the management packet with a priority index of data that the meter itself is to transmit, and when the priority indicated by the priority index of the data that the meter itself is to transmit is higher than or equal to the priority indicated by the priority index included in the management packet, the judgment unit 200 judges that the meter itself has obtained permission to transmit the data. It should be noted that the judgment unit 200 will be described in detail below.

The communication processing unit 210 communicates with the communication processing unit 110 of the power-consumption-information collecting apparatus 1, to transmit and receive data. Here, the transmission unit 211 and the receiving unit 212 included in the communication processing unit 210 will be described.

When the judgment unit 200 judges that the meter itself has obtained permission to transmit data, the transmission unit 211 transmits the data in a predetermined period.

Specifically, when it is judged from terminal identification information that the meter itself has obtained permission to transmit data, the transmission unit 211 judges, before transmitting data, whether or not data is being transmitted from a power meter 2 with a device control function of another home appliance to the power-consumption-information collecting apparatus 1. Then, the transmission unit 211 does not transmit data when it is judged that data is being transmitted from the power meter 2 with a device control function of the other home appliance, whereas the transmission unit 211 transmits data when it is judged that data is not being transmitted from the power meter 2 with a device control function of the other home appliance.

Further, when it is judged from the priority index that the meter itself has obtained permission to transmit data, the transmission unit 211 transmits the data, without making the above judgment. It should be noted that the transmission unit 211 will be descried in detail below.

The receiving unit 212 receives, from the power-consumption-information collecting apparatus 1, a management packet including terminal identification information that indicates a power meter 2 with a device control function of a home appliance that is permitted to transmit data in a predetermined period, and the priority index that indicates the priority of data that can be transmitted in the predetermined period.

Next is a description of the detailed configuration of the judgment unit 200.

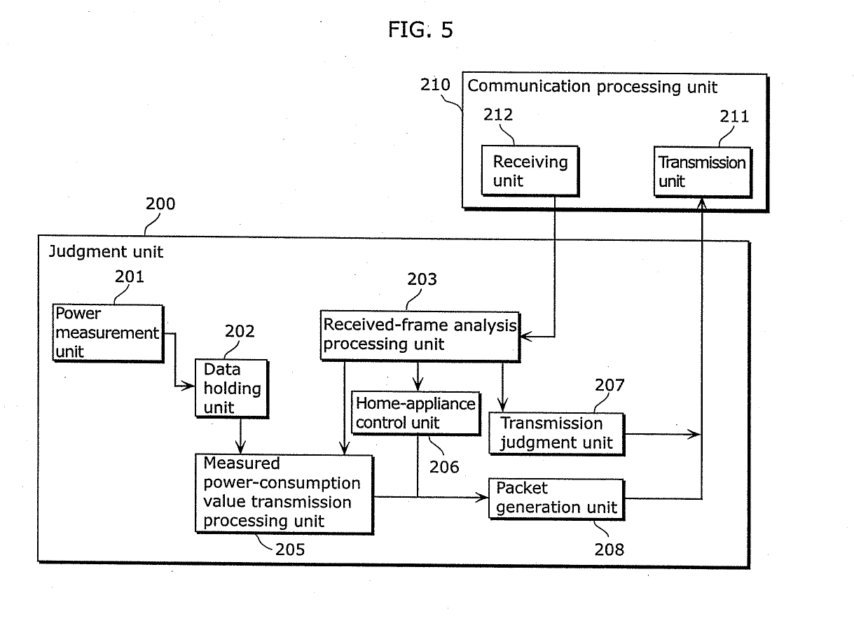

FIG. 5 shows the configuration of the judgment unit 200 in Embodiment 1 of the present invention.

As shown in FIG. 5, the judgment unit 200 includes a power measurement unit 201, a data holding unit 202, a received-frame analysis processing unit 203, a measured power-consumption value transmission processing unit 205, a home-appliance control unit 206, a transmission judgment unit 207, and a packet generation unit 208.

The received-frame analysis processing unit 203 analyzes data received from the power-consumption-information collecting apparatus 1 via the receiving unit 212 of the communication processing unit 210, and transmits, to the measured power-consumption value transmission processing unit 205, information indicating the interval at which power consumption data is transmitted, the accuracy of measured data, a sampling frequency for measurement, and the type of transmitted data.

Further, the received-frame analysis processing unit 203 transmits, to the home-appliance control unit 206, instructions for the control and setting of a home appliance received from the power-consumption-information collecting apparatus 1 via the receiving unit 212.

Furthermore, the received-frame analysis processing unit 203 transmits, to the transmission judgment unit 207, terminal identification information and a priority index that are included in a management packet received from the power-consumption-information collecting apparatus 1 via the receiving unit 212.

The home-appliance control unit 206 executes and responds to the instructions for the control and setting of the home appliance received from the received-frame analysis processing unit 203. Further, the home-appliance control unit 206 also has a function of transmitting, to the power-consumption-information collecting apparatus 1 via the receiving unit 212, a control history, a setting pattern, reservation schedule information, unique information, and the state of a device, and the like, according to instructions from a user.

Here, specific examples of the state of a device change depending on the device. Specific examples of the device state include the state of a hot-water storage tank of a fuel cell, the amount of power generation of a solar cell, the amount of remaining storage battery power, the state of a hot-water storage tank of a natural refrigerant heat pump water heater, the amount of power generation of a fuel cell, and the like.

The power measurement unit 201 measures power consumption data of a home appliance.

The data holding unit 202 is a memory that stores power consumption data of a home appliance measured by the power measurement unit 201.

The measured power-consumption value transmission processing unit 205 reads power consumption data of the home appliance measured by the power measurement unit 201 from the data holding unit 202, and receives information indicating the interval at which power consumption data is transmitted, and the like from the received-frame analysis processing unit 203.

The packet generation unit 208 generates a packet including data such as the state of a home appliance received from the home-appliance control unit 206, and power consumption data received from the measured power-consumption value transmission processing unit 205. Then, the packet generation unit 208 transmits the generated packet to the transmission unit 211, so as to transmit data to the power-consumption-information collecting apparatus 1 in accordance with the transmission interval received from the measured power-consumption value transmission processing unit 205.

Here, the transmission judgment unit 207 sets a priority index for data that the packet generation unit 208 transmits to the power-consumption-information collecting apparatus 1.

The transmission judgment unit 207 determines a priority index of data to be transmitted to the power-consumption-information collecting apparatus 1, according to the state of a home appliance controlled by the meter itself, the sate being indicated by data including at least one of power consumption data, the amount of stored hot water, the amount of power generation, remaining battery power, and the operation mode of the home appliance. Specifically, the transmission judgment unit 207 sets a priority index of data to be transmitted, with reference to priority index information corresponding to the type of data designated by the home-appliance control transmission processing unit 107 of the power-consumption-information collecting apparatus 1.

Then, the transmission judgment unit 207 compares the priority index included in the management packet received from the received-frame analysis processing unit 203 with the priority index of data that the meter itself is to transmit, and when the priority indicated by the priority index of data that the meter itself is to transmit is higher than or equal to the priority indicated by the priority index included in the management packet, the transmission judgment unit 207 judges that the meter itself has obtained permission to transmit data.

Further, the transmission judgment unit 207 judges whether or not the meter itself has obtained permission to transmit data, by comparing terminal identification information included in the management packet received from the received-frame analysis processing unit 203 with terminal identification information of the meter itself.

It should be noted that although in the present embodiment, the transmission judgment unit 207 sets a priority index of data based on priority index information corresponding to the type of data designated by the power-consumption-information collecting apparatus 1, the transmission judgment unit 207 may set a priority index autonomously.

Next is a description of the detailed configuration of the transmission unit 211 of the communication processing unit 210.

FIG. 6 shows the configuration of the transmission unit 211 of the communication processing unit 210 in Embodiment 1 of the present invention.

As described above, the communication processing unit 210 includes the receiving unit 212 and the transmission unit 211, and as shown in FIG. 6, the transmission unit 211 has a transmission control unit 303, a backoff control unit 304, and a transmission processing unit 305.

The receiving unit 212 identifies the packet received from the transmission unit 111 of the communication processing unit 110 of the power-consumption-information collecting apparatus 1, and if the received packet is a beacon, the receiving unit 212 extracts information in the beacon, and delivers the extracted data to the transmission control unit 303. Further, if the received packet is addressed to the meter itself, the receiving unit 212 delivers the received data to the received-frame analysis processing unit 203.

The transmission control unit 303 transmits, to the backoff control unit 304 or the transmission processing unit 305, transmission data that is the data received from the transmission judgment unit 207 and the packet generation unit 208. Further, the transmission control unit 303 sets a carrier sense time using the extracted data received from the receiving unit 212. It should be noted that the detailed configuration of the transmission control unit 303 will be described below.

The transmission processing unit 305 immediately transmits the transmission data received from the transmission control unit 303.

The backoff control unit 304 delivers the transmission data to the transmission unit if a channel is idle, after performing carrier sense for the carrier sense time set by the transmission control unit 303. Further, if the channel is busy, the backoff control unit 304 notifies the transmission control unit 303 thereof.

Specifically, before transmitting data, the backoff control unit 304 judges whether or not data is being transmitted from a power meter 2 with a device control function of another home appliance to the power-consumption-information collecting apparatus 1. Then, the backoff control unit 304 does not transmit data when judging that data is being transmitted from the power meter 2 with a device control function of the other home appliance (channel is busy), whereas the backoff control unit 304 transmits data when judging that data is not being transmitted from the power meter 2 with a device control function of the other home appliance (channel is idle). Next is a description of the detailed configuration of the transmission control unit 303.

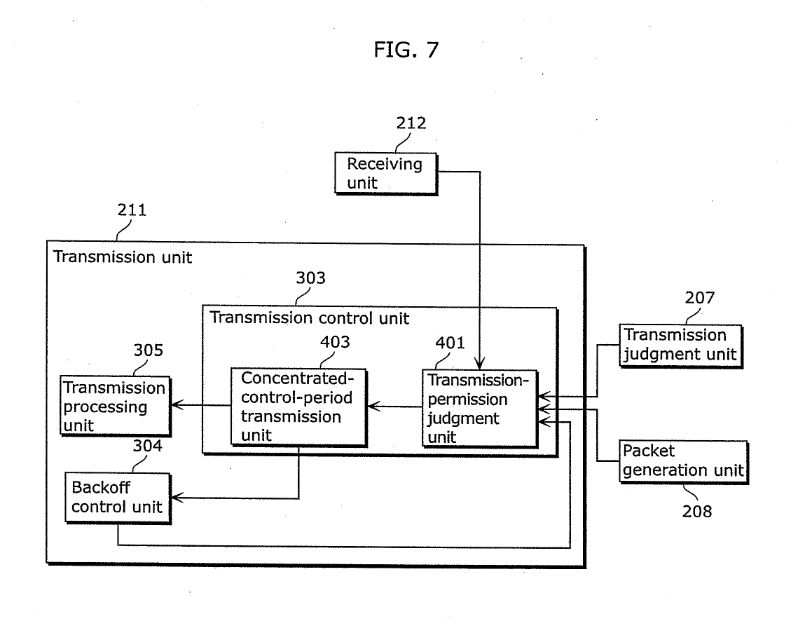

FIG. 7 shows the configuration of the transmission control unit 303 in Embodiment 1 of the present invention.

As shown in FIG. 7, the transmission control unit 303 includes a transmission-permission judgment unit 401 and a concentrated-control-period transmission unit 403. It should be noted that in FIG. 7, the same numerals are used for the same constituent elements as those in FIG. 6, and a description thereof is omitted.

The transmission-permission judgment unit 401 determines a transmission period for transmission data, with reference to super frame information included in the extracted data received from the receiving unit 212 and the result of judgment made by the transmission judgment unit 207.

Specifically, when the transmission judgment unit 207 judges from terminal identification information that the meter itself has obtained permission to transmit data, the transmission-permission judgment unit 401 judges that the transmission data is to be transmitted in the concentrated control period. Further, when the transmission judgment unit 207 judges from the priority index, that the meter itself has obtained permission to transmit data, the transmission-permission judgment unit 401 judges that interrupt transmission of the transmission data is to be performed in the concentrated control period.

Then, when judging that transmission data is to be transmitted in the concentrated control period or interrupt transmission of the transmission data is performed in the concentrated control period, the transmission-permission judgment unit 401 delivers the transmission data to the concentrated-control-period transmission unit 403.

When the transmission-permission judgment unit 401 judges that transmission is to be performed in the concentrated control period, the concentrated-control-period transmission unit 403 delivers a backoff time and the transmission data to the backoff control unit 304, based on an algorithm for transmission in the concentrated control period.

Further, when the transmission-permission judgment unit 401 judges that interrupt transmission is to be performed in the concentrated control period, the concentrated-control-period transmission unit 403 delivers the transmission data to the transmission processing unit 305, based on an algorithm for interrupt transmission in the concentrated control period.

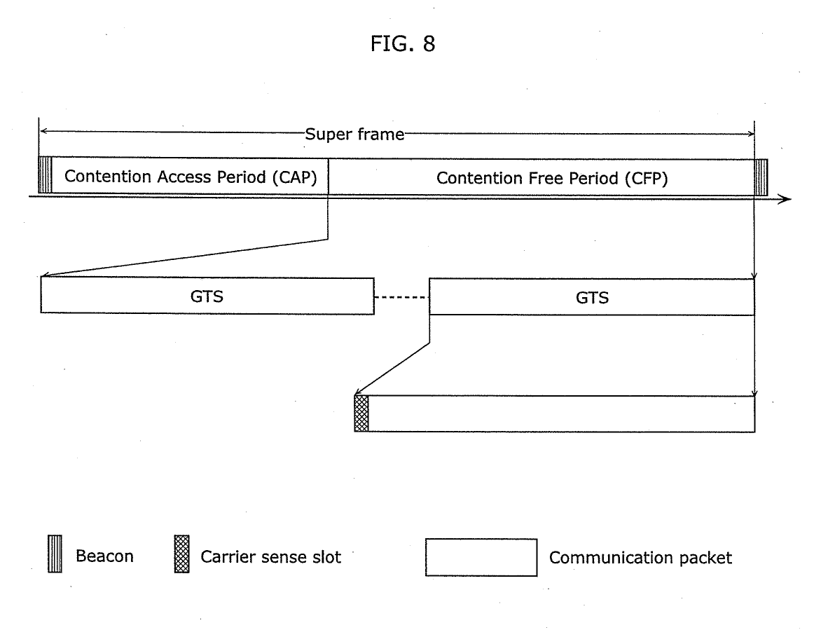

FIG. 8 shows the frame structure of the wireless communication system in Embodiment 1 of the present invention.

As shown in FIG. 8, a channel is divided into a contention period (CAP) and a concentrated control period (CFP) in the present embodiment, as with the super frame in conformity with the 802.15.4 standard. During the contention period, the terminals (power meters 2 with a device control function) communicate with each other using a decentralized autonomous multiplex communication system, namely, slotted CSMA/CA, for example.

Further, when a terminal desires to transmit data in the concentrated control period, the terminal makes a request to the base station (the power-consumption-information collecting apparatus 1) in the contention period. The base station transmits, in response, the result indicating whether or not transmission is permitted to the terminal that made the request. The following is a description of priority control in the concentrated control period, which is a feature of the present invention.

The concentrated control period includes a plurality of assignment periods (guaranteed time slots/GTSs), and furthermore, one carrier sense slot is provided in the head of each GTS. The base station periodically transmits beacons.

Here, information in each beacon includes at least “the number of GTSs, the length of each GTS, a start time slot, an ID of an assigned terminal, and a priority index of data that can be transmitted other than the data of the assigned terminal”, which indicates the length of a super frame (the number of time slots), the start time slot of the concentrated control period (CFP), and GTS assignment information.

Next is a description of processing performed by the power-consumption-information collecting apparatus 1.

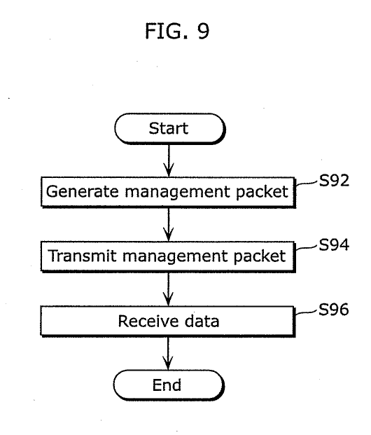

FIG. 9 is a flowchart showing an example of processing performed by the power-consumption-information collecting apparatus 1 in Embodiment 1 of the present invention.

As shown in FIG. 9, first, the management packet generation unit 100 generates a management packet including terminal identification information that indicates a power meter 2 with a device control function permitted to transmit data in a predetermined period, and a priority index of data permitted to be transmitted in the predetermined period (S92).

Next, the transmission unit 111 transmits the management packet generated by the management packet generation unit 100 to all the power meters 2 with a device control function (S94).

Then, the receiving unit 112 receives data in the predetermined period from the power meter 2 with a device control function that is determined based on the terminal identification information and the priority index (S96).

Next is a description of processing performed by the power meters 2 with a device control function.

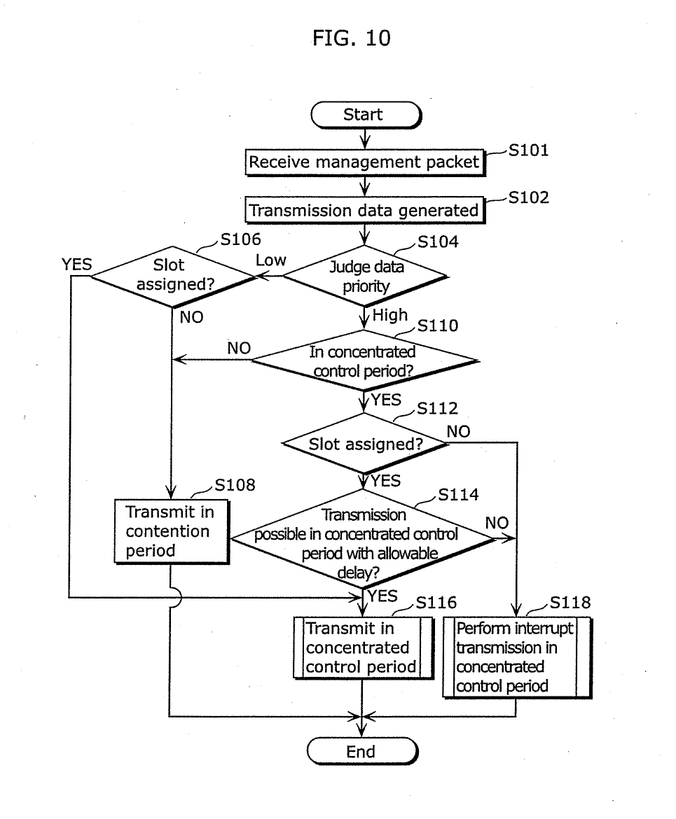

FIG. 10 is a flowchart for describing a transmission period judgment algorithm performed by the power meters 2 with a device control function in Embodiment 1 of the present invention.

As shown in FIG. 10, first, the receiving unit 212 of a power meter 2 with a device control function receives a management packet from the power-consumption-information collecting apparatus 1 (S101).

Then, when data to be transmitted is generated (S102), the judgment unit 200 of the power meter 2 with a device control function judges the priority of the data to be transmitted (S104).

Specifically, the judgment unit 200 judges whether or not the priority indicated by the priority index of the data that the meter itself is to transmit is higher than or equal to the priority indicated by the priority index included in the management packet.

Then, when judging that the priority of the data to be transmitted is lower than the priority indicated by the priority index included in the management packet (“low” in S104), the judgment unit 200 judges whether or not a slot is assigned to the meter itself (S106). Specifically, the judgment unit 200 judges whether or not the meter itself has obtained permission to transmit data, by comparing terminal identification information included in the management packet with the terminal identification information of the meter itself.

Then, when the judgment unit 200 judges that a slot is assigned to the meter itself (YES in S106), the transmission unit 211 transmits data in the assigned period in the concentrated control period (S116). Further, when the judgment unit 200 judges that a slot is not assigned to the meter itself (NO in S106), the transmission unit 211 transmits data in the contention period (S108).

Further, when judging that the priority of the data to be transmitted is higher than the priority indicated by the priority index included in the management packet (“high” in S104), the judgment unit 200 judges whether or not the current position of the super frame is in the concentrated control period (S110).

When judging that the current position of the super frame is in the contention period (NO in S110), the judgment unit 200 transmits data in the contention period, regardless of whether or not a slot is assigned (S108).

When judging that the current position of the super frame is in the concentrated control period (YES in S110), the judgment unit 200 judges whether or not a slot is assigned to the meter itself (S112).

Then, when judging that a slot is assigned to the meter itself (YES in S112), the judgment unit 200 calculates a time (delay time) until when the period assigned to the meter itself comes, and judges whether or not the delay time is within the range of an allowable delay associated with the priority of data (S114).

Then, when the judgment unit 200 judges that the delay time is within the range of the allowable delay (YES in S114), the transmission unit 211 stands by until the period assigned to the meter itself comes, and transmits data in the concentrated control period (S116). It should be noted that processing performed by the transmission unit 211 to transmit data in the concentrated control period will be descried in detail below.

Further, when the judgment unit 200 judges that a slot is not assigned to the meter itself (NO in S112), or when the delay time until when the period assigned to the meter itself comes exceeds the allowable delay associated with the priority of data (NO in S114), the transmission unit 211 performs interrupt transmission in the concentrated control period (S118). It should be noted that processing performed by the transmission unit 211 to perform interrupt transmission in the concentrated control period will be described in detail below.

The above processing completes the processing performed by the power meter 2 with a device control function.

Next is a detailed description of processing performed by the transmission unit 211 to perform interrupt transmission in the concentrated control period (S118 in FIG. 10).

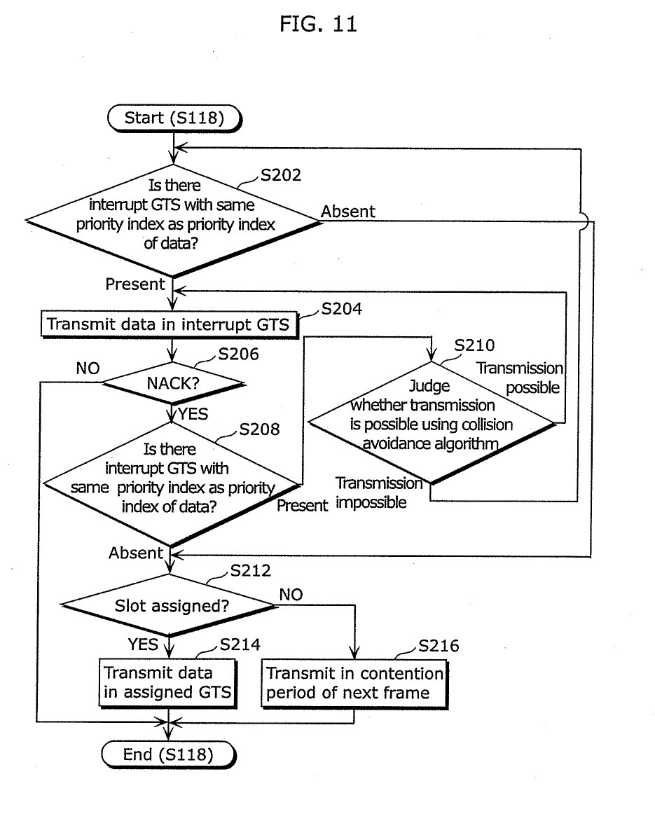

FIG. 11 is a flowchart for describing the algorithm for interrupt transmission in the concentrated control period performed by the power meters 2 with a device control function in Embodiment 1 of the present invention.

A power meter 2 with a device control function that has determined, using the above transmission period judgment algorithm, that the power meter performs interrupt transmission in the concentrated control period transmits data, in accordance with the algorithm for interrupt transmission in the concentrated control period described below.

As shown in FIG. 11, first, the transmission unit 211 of the power meter 2 with a device control function that performs interrupt transmission judges, with reference to information in a beacon, whether there is an assignment period that is assigned to another apparatus, and has the same priority index as the priority index of data that the meter itself is to transmit (hereinafter, referred to as interrupt GTS) (S202).

When judging that there is an interrupt GTS (“present” in S202), the transmission unit 211 immediately transmits data (hereinafter, referred to as interrupt packet) in the interrupt GTS (S204).

Here, when high priority data pieces with the same priority are generated in the power meters 2 with a device control function at the same time, a collision of interrupt packets occurs. Accordingly, after transmitting an interrupt packet, the transmission unit 211 judges whether or not a NACK packet notified from the power-consumption-information collecting apparatus 1 has been received (S206).

When judging that a NACK packet has not been received (NO in S206), the transmission unit 211 ends processing since the interrupt packet has been successfully transmitted to the power-consumption-information collecting apparatus 1.

Further, when judging that a NACK packet has been received (YES in S206), the transmission unit 211 judges that the interrupt packet transmitted by the meter itself has collided with an interrupt packet from another apparatus, and judges again whether there is an interrupt GTS (S208).

Then, when judging that there is an interrupt GTS (“present” in S208), before transmitting the interrupt packet, the transmission unit 211 judges, based on a collision avoidance algorithm, whether or not transmission is possible, in order to avoid the occurrence of a packet collision again (S210).

The collision avoidance algorithm may be a conventional packet collision avoidance algorithm. For example, p-persistent can be used as the collision avoidance algorithm. Specifically, a terminal generates a random number, and if the generated random number is greater than a specific value p, the terminal that generated the random number transmits a packet. Further, if the generated random number is smaller than the value p, the terminal that generated the random number waits for the next interrupt GTS. Alternatively, a terminal to transmit a packet may be randomly selected from among a plurality of interrupt GTS candidates.

Then, when judging that transmission is possible based on the collision avoidance algorithm (“transmission possible” in S210), the transmission unit 211 transmits data in an interrupt GTS (S204). Further, when judging that transmission is not possible based on the collision avoidance algorithm (“transmission impossible” in S210), the transmission unit 211 judges again whether or not there is an interrupt GTS (S202).

Further, when judging that there is no interrupt GTS (“absent” in S202 or in S208), or when judging that there is no interrupt GTS with the same priority index as the priority index of data that the meter itself is to transmit (“absent” in S202), the transmission unit 211 judges whether or not a slot is assigned to the meter itself (S212).

When judging that a slot is not assigned to the meter itself (“NO” in S212), the transmission unit 211 performs data communication in the contention period of the next frame (S216). Further, when judging that a slot is assigned to the meter itself (“YES” in S212), the transmission unit 211 transmits data in the period assigned to the meter itself (S214).

The above processing completes the processing performed by the transmission unit 211 to perform interrupt transmission in the concentrated control period (S118 in FIG. 10).

Next is a detailed description of processing performed by the transmission unit 211 to transmit data in the concentrated control period (S116 in FIG. 10).

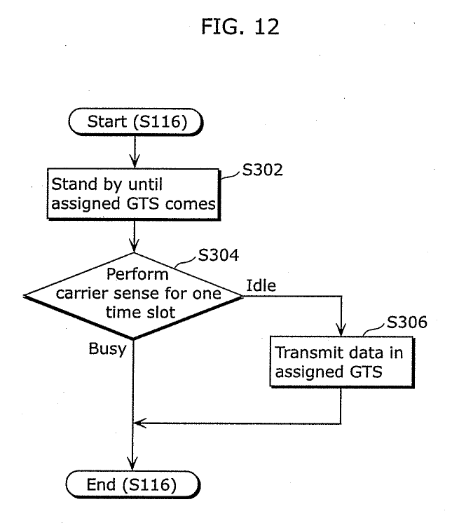

FIG. 12 is a flowchart for describing the algorithm for transmission in the concentrated control period performed by the power meters 2 with a device control function in Embodiment 1 of the present invention.

A power meter 2 with a device control function that has determined, using the above transmission period judgment algorithm and the above algorithm for interrupt transmission in the concentrated control period, that data is to be transmitted in the concentrated control period, transmits data in accordance with the algorithm for transmission in the concentrated control period described below.

As shown in FIG. 12, first, the transmission unit 211 of the power meter 2 with a device control function stands by until a GTS period assigned to the meter itself comes (S302), and performs carrier sense for one time slot before transmitting data when the assigned GTS period comes (S304).

At this time, if a channel is idle (“idle” in S304), the transmission unit 211 transmits data (S306). Further, if the channel is busy (“busy” in S304), the transmission unit 211 ends processing, and again performs the processing of the transmission period judgment algorithm shown in FIG. 10.

According to this configuration, when high priority data is generated in the power meter 2 with a device control function, it is determined whether or not to perform interrupt transmission of the priority data in the concentrated control period, based on the priority and allowable delay of the data, using the transmission period judgment algorithm. If it is determined that interrupt transmission is to be performed in the concentrated control period, the data is transmitted in a GTS period with the same priority index as the priority index of the transmission data, using the algorithm for interrupt transmission in the concentrated control period. A power meter 2 with a device control function that transmits data in the concentrated control period in a normal manner can prevent a packet collision with the interrupt terminal by performing carrier sense before transmission, and can preferentially transmit high priority data.

The above processing completes the processing performed by the transmission unit 211 to transmit data in the concentrated control period (S116 in FIG. 10).

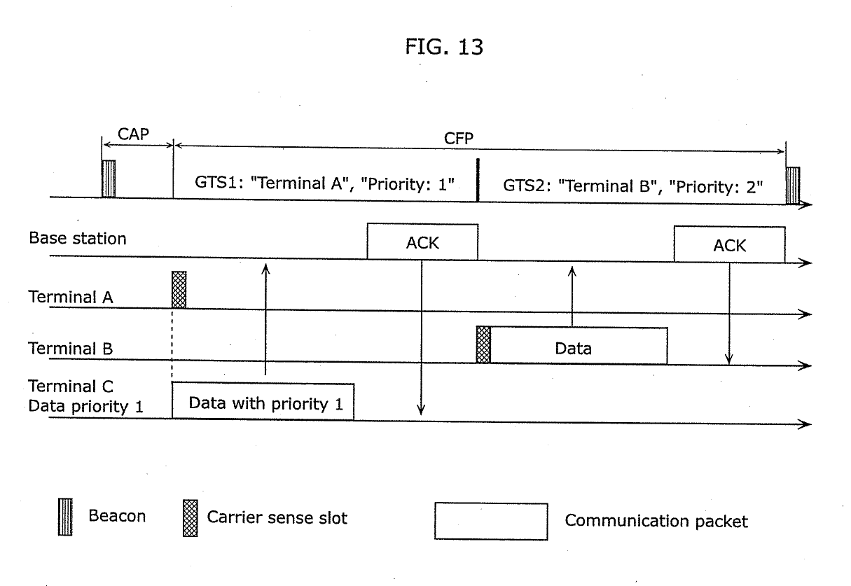

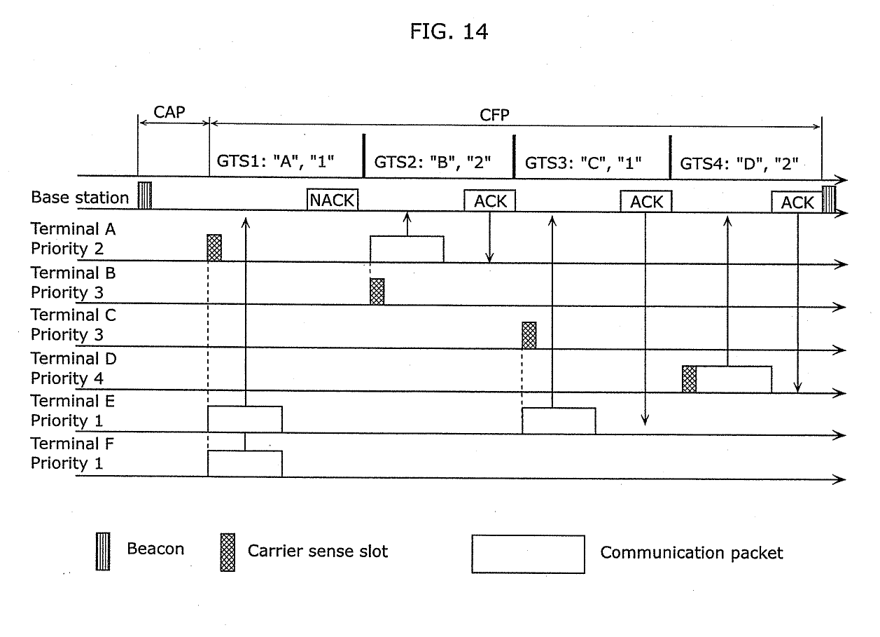

The following is a detailed description of scenarios executed by the power-consumption collecting system in Embodiment 1 of the present invention, with reference to FIGS. 13 and 14.

FIG. 13 illustrates Scenario 1 executed by the power-consumption collecting system in Embodiment 1 of the present invention.

As shown in FIG. 13, the configuration in the scenario includes a base station (the power-consumption-information collecting apparatus 1), and Terminals A, B, and C (the power meters 2 with a device control function).

The base station assigns GTS1 to Terminal A, and GTS2 to Terminal B, using a beacon. Furthermore, the base station sets a priority index for which interruption is allowed to 1 for GTS1, and 2 for GTS2.

In this manner, the base station generates a management packet including terminal identification information pieces and priority indexes respectively corresponding to two or more GTS periods, and transmits the generated packet to the terminals. Further, Terminal C does not have an assigned GTS, but has transmission data with a priority index 1.

Terminal C judges, with reference to information in the beacon, that the priority index for which interruption is allowed for GTS1 is equal to the priority index of the transmission data of the terminal itself, and immediately transmits data when the super frame comes to the position of GTS1.

Terminal A performs carrier sense for one time slot before transmitting data when the super frame comes to the position of GTS1 assigned to the terminal itself. Terminal A detects, while performing carrier sense, that a channel is busy due to data transmission by Terminal C, and stops data transmission, which can avoid a collision with the packet from Terminal C.

In GTS2 next, since there is no interrupt data, Terminal B detects that the channel is idle after performing carrier sense, and transmits data.

FIG. 14 illustrates Scenario 2 executed by the power-consumption collecting system in Embodiment 1 of the present invention.

As shown in FIG. 14, the configuration in the scenario includes a base station (the power-consumption-information collecting apparatus 1), Terminals A, B, C, D, E, and F (the power meters 2 with a device control function).

The base station assigns, using a beacon, GTS1 to Terminal A, GTS2 to Terminal B, GTS3 to Terminal C, and GTS4 to Terminal D. Furthermore, the base station sets the priority index for which interruption is allowed to 1 for GTS1, 2 for GTS2, 1 for GTS3, and 2 for GTS4. Terminals E and F do not have an assigned GTS, but have transmission data with a priority index 1.

Terminals E and F judge, with reference to the information in the beacon, that the priority index for which interruption is allowed for GTS1 is equal to the priority index of the transmission data of the terminals themselves, and transmit data immediately after the super frame comes to the position of GTS1. Terminal A detects that a channel is busy and cancels transmission.

Here, since Terminals E and F transmit data at the same time, a collision of packets occurs. Thus, the base station detects errors in the received packets and transmits a NACK packet.

In GTS2 next, since there is no interrupt data, Terminal B detects that the channel is idle after performing carrier sense, and transmits data.

Although Terminals E and F judge, with reference to the information in the beacon again, the priority index for which interruption is allowed for GTS3 is equal to the priority index of the transmission data of the terminals themselves, the collision avoidance algorithm is applied in GTS3 since the packets that Terminals E and F transmitted immediately before collided.

Then, based on the collision avoidance algorithm, Terminal E judges that transmission is possible, and transmits data. Terminal F judges that transmission is not possible based on the collision avoidance algorithm, and cancels transmission of data. Terminal C detects that the channel is busy as a result of carrier sense, and cancels transmission of data, thereby enabling data to be transmitted from Terminal E while preventing a collision with the data from Terminal C.

In GTS4 next, since there is no interrupt data, Terminal D detects that the channel is idle after performing carrier sense, and transmits data.

According to the configuration, when high priority data is generated in a terminal, it is possible to determine, using the transmission period judgment algorithm, whether or not interrupt transmission of priority data is to be performed in the concentrated control period, based on the priority and allowable delay of data. When it is determined that interrupt transmission is to be performed in the concentrated control period, data is transmitted in a GTS period with the same priority index as that of transmission data, using the algorithm for interrupt transmission in the concentrated control period. A terminal that transmits data in the concentrated control period in a normal manner can prevent a packet collision with a packet from an interrupt terminal by performing carrier sense before transmission, and can preferentially transmit high priority data. Further, when packets from interrupt terminals collide, a collision of the packets from the interrupt terminals can be avoided by using the collision avoidance algorithm.

### Embodiment 2

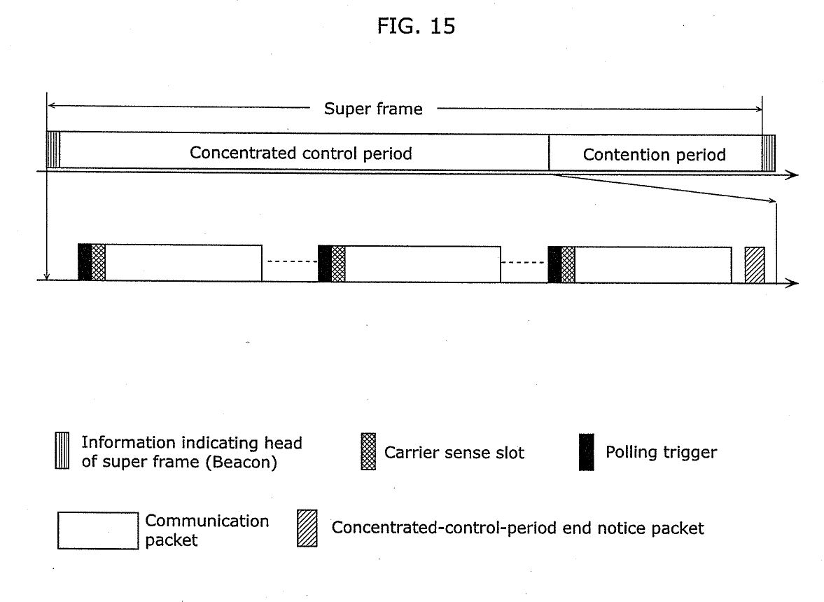

FIG. 15 shows a frame structure of a wireless communication system in Embodiment 2 of the present invention. Embodiment 2 describes a configuration in which the present invention is applied to a general polling method.

As shown in FIG. 15, a super frame in Embodiment 2 includes a concentrated control period and a contention period. The concentrated control period starts with a beacon that is information indicating the head of the super frame, and ends with a concentrated-control-period end notice packet. The concentrated-control-period end notice packet includes at least information on the length of the contention period. The contention period starts with the concentrated-control-period end notice packet, and ends at the length described in the concentrated-control-period end notice packet.

A terminal (power meter 2 with a device control function) makes polling reservation to a base station (the power-consumption-information collecting apparatus 1) in the contention period, using a decentralized autonomous wireless communication system, namely, CSMA/CA, for example, when data is to be transmitted in the concentrated control period (polling period), as in Embodiment 1.

The base station permits or does not permit the wireless terminal that makes polling reservation to be registered in a polling list, and notifies the wireless terminal of the result. With reference to the result indicating that polling reservation is permitted, the terminal transmits data using a transmission period judgment algorithm described below.

Further, the base station transmits a beacon to terminals, the beacon notifying the terminals of the start of the concentrated control period. Information on the polling list may be included in the beacon, or notified using a different packet.

Furthermore, the base station does not assign a slot to each terminal, and instead thereof, collects data by notifying a terminal from which data is to be collected of a polling trigger. Specifically, the base station transmits a polling trigger to terminals in the order thereof on the polling list. Each polling trigger includes at least an ID of a wireless terminal that is permitted to transmit data and a priority index for which interruption is allowed.

Specifically, the management packet generation unit 100 of the power-consumption-information collecting apparatus 1 generates, as a management packet, a polling trigger including terminal identification information that indicates a power meter 2 with a device control function permitted to transmit data in a predetermined period, and a priority index of data permitted to be transmitted in the predetermined period.

It should be noted that the configuration of the power-consumption collecting system (the power-consumption-information collecting apparatus 1 and the power meters 2 with a device control function) in Embodiment 2 of the present invention is the same as the configuration of the power-consumption collecting system in Embodiment 1 above, and thus a detailed description of the configuration is omitted. Also, processing performed by the power-consumption-information collecting apparatus 1 in Embodiment 2 of the present invention is the same as that described in Embodiment 1, and thus a description thereof is omitted.

Next is a description of processing performed by the power meters 2 with a device control function in Embodiment 2 of the present invention.

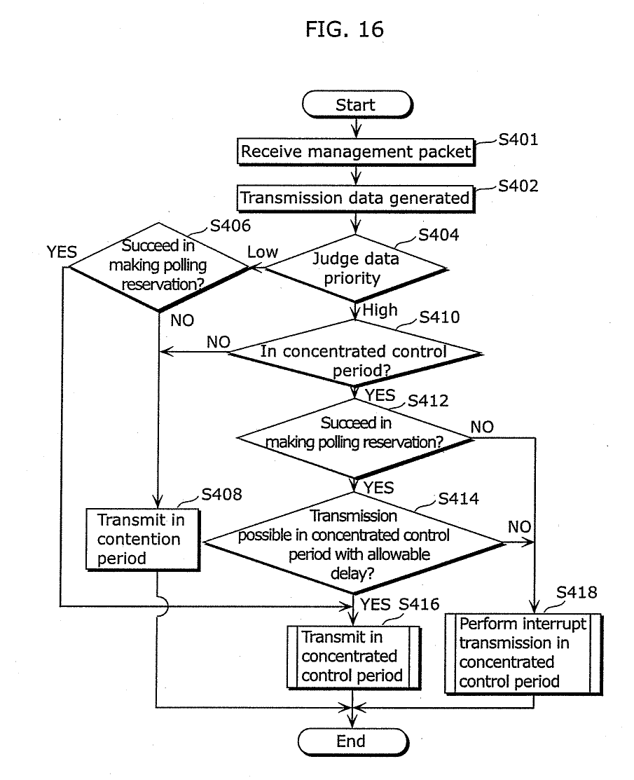

FIG. 16 is a flowchart for describing the transmission period judgment algorithm performed by the power meters 2 with a device control function in Embodiment 2 of the present invention.

As shown in FIG. 16, first, the receiving unit 212 of a power meter 2 with a device control function receives a polling trigger as a management packet from the power-consumption-information collecting apparatus 1 (S401).

Then, when data to be transmitted is generated (S402), the judgment unit 200 of the power meter 2 with a device control function judges a priority of the data to be transmitted (S404).

Specifically, the judgment unit 200 judges whether or not the priority indicated by a priority index of the data that the meter itself is to transmit is greater than or equal to the priority indicated by a priority index included in the management packet.

Then, when judging that the priority of the data to be transmitted is lower than the priority indicated by the priority index included in the management packet (“low” in S404), the judgment unit 200 judges whether or not the meter itself has succeeded in making polling reservation (S406). Specifically, the judgment unit 200 judges whether or not the meter itself has obtained permission to transmit data by comparing terminal identification information included in the management packet with terminal identification information of the meter itself.

Then, when the judgment unit 200 judges that the meter itself has succeeded in making polling reservation (YES in S406), the transmission unit 211 transmits data in an assigned period in the concentrated control period (S416). Further, when the judgment unit 200 judges that the meter itself has failed in making polling reservation (NO in S406), the transmission unit 211 transmits data in the contention period (S408).

Further, when judging that the priority of the data to be transmitted is higher than the priority indicated by the priority index included in the management packet (“high” in S404), the judgment unit 200 judges whether or not the current position of the super frame is in the concentrated control period (S410).

When judging that the current position of the super frame is in the contention period (NO in S410), the judgment unit 200 transmits data in the contention period, regardless of whether or not the meter itself is on the polling list (S408).

When judging that the current position of the super frame is in the concentrated control period (YES in S410), the judgment unit 200 judges whether or not the meter itself has succeeded in making polling reservation (S412).

Then, when judging that the meter itself has succeeded in making polling reservation (YES in S412), the judgment unit 200 calculates a time (delay time) until when a polling trigger indicating the meter itself comes, and judges whether or not the delay time is within the range of the allowable delay associated with the priority of data (S414).

Then, when the judgment unit 200 judges that the delay time is within the range of the allowable delay (YES in S414), the transmission unit 211 stands by until the polling trigger indicating the meter itself comes, and transmits data in the concentrated control period based on the polling trigger indicating the meter itself (S416). It should be noted that details of processing performed by the transmission unit 211 to transmit data in the concentrated control period will be described below.

Further, when the judgment unit 200 judges that the meter itself has failed in making polling reservation (NO in S412), or when a delay time until when the polling trigger indicating the meter itself comes exceeds the allowable delay associated with the priority of data (NO in S414), the transmission unit 211 performs interrupt transmission in the concentrated control period (S418). It should be noted that details of processing performed by the transmission unit 211 to perform interrupt transmission in the concentrated control period will be described below.

The above processing completes the processing performed by the power meters 2 with a device control function in Embodiment 2 of the present invention.

Next is a detailed description of processing performed by the transmission unit 211 to perform interrupt transmission in the concentrated control period (S418 in FIG. 16).

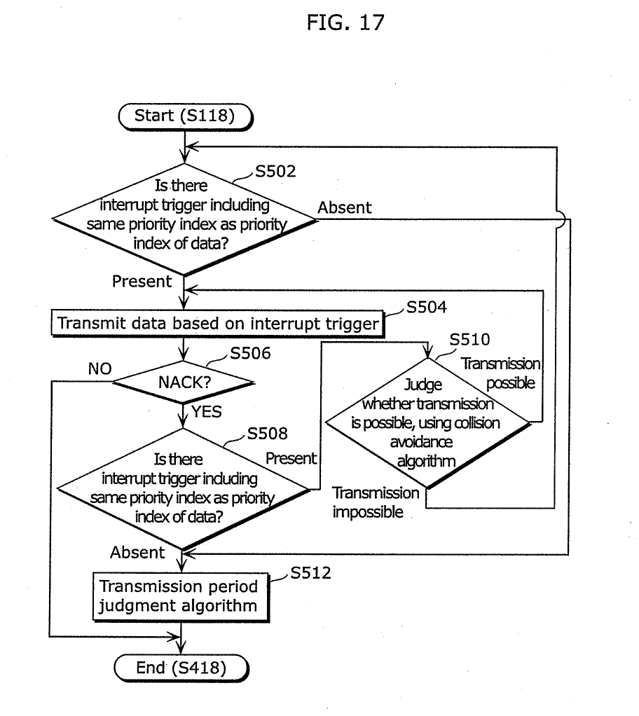

FIG. 17 is a flowchart for describing an algorithm for interrupt transmission in the concentrated control period performed by the power meters 2 with a device control function in Embodiment 2 of the present invention.

A power meter 2 with a device control function that has determined, using the transmission period judgment algorithm in Embodiment 2 above, that interrupt transmission is to be performed in the concentrated control period transmits data in accordance with the algorithm for interrupt transmission in the concentrated control period described below.

As shown in FIG. 17, first, the transmission unit 211 of the power meter 2 with a device control function that performs interrupt transmission judges, with reference to information in a polling trigger, whether or not there is a polling trigger including a priority index that is the same as the priority index of the data that the meter itself is to transmit (hereinafter, referred to as an interrupt trigger) (S502).

When judging that there is an interrupt trigger (“present” in S502), the transmission unit 211 immediately transmits data (hereinafter, referred to as an interrupt packet) based on the interrupt trigger (S504).

Here, when high priority data pieces having the same priority are generated in the power meters 2 with a device control function at the same time, a collision of interrupt packets occurs. Accordingly, the transmission unit 211 judges whether or not a NACK packet notified from the power-consumption-information collecting apparatus 1 has been received after transmitting the interrupt packet (S506).

When judging that a NACK packet is not received (NO in S506), the transmission unit 211 ends processing since the interrupt packet was successfully transmitted to the power-consumption-information collecting apparatus 1.

Further, when judging that a NACK packet has been received (YES in S506), the transmission unit 211 judges that the interrupt packet transmitted by the meter itself has collided with an interrupt packet from another apparatus, and again judges whether or not there is an interrupt trigger (S508).

When judging that there is an interrupt trigger (“present” in S508), in order to prevent a packet collision from occurring again, the transmission unit 211 judges before transmitting an interrupt packet whether or not transmission is possible based on a collision avoidance algorithm (S510).

The collision avoidance algorithm may be a conventional packet collision avoidance algorithm. For example, p-persistent can be used as a collision avoidance algorithm. Specifically, a terminal generates a random number, and if the generated random number is greater than a specific value p, the terminal that has generated the random number transmits a packet. Further, if the generated random number is smaller than the value p, the terminal that has generated the random number waits until a next interrupt trigger comes. Alternatively, a terminal that is to transmit a packet may be randomly selected from among a plurality of interrupt trigger candidates.

Then, when judging that transmission is possible based on the collision avoidance algorithm (“transmission possible” in S510), the transmission unit 211 transmits data based on an interrupt trigger (S504). Further, when judging that transmission is not possible based on the collision avoidance algorithm (“transmission impossible” in S510), the transmission unit 211 judges again whether or not there is an interrupt trigger (S502).

Further, when judging that there is no interrupt trigger (“absent” in S502 or S508), and when judging that an interrupt trigger including the same priority index as the priority index of the data that the meter itself is to transmit (“absent” in S502), the transmission unit 211 again performs processing for the transmission period judgment algorithm shown in FIG. 16 (S512).

The above processing completes the processing performed by the transmission unit 211 to perform interrupt transmission in the concentrated control period (S418 in FIG. 16).

Next is a detailed description of processing performed by the transmission unit 211 to transmit data in the concentrated control period (S416 in FIG. 16).

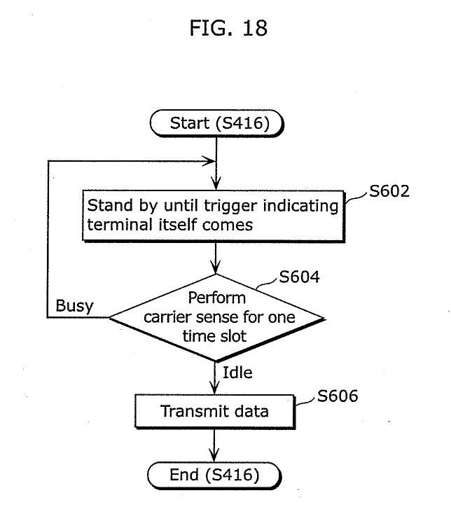

FIG. 18 is a flowchart for describing an algorithm for transmission in the concentrated control period performed by the power meters 2 with a device control function in Embodiment 2 of the present invention.

A power meter 2 with a device control function that has determined, using the transmission period judgment algorithm in Embodiment 2 described above, that data is to be transmitted in the concentrated control period transmits data in accordance with the algorithm for transmission in the concentrated control period described below.

As shown in FIG. 18, first, the transmission unit 211 of the power meter 2 with a device control function stands by until a polling trigger indicating the meter itself comes (S602), and performs carrier sense for one time slot before transmitting data (S604) when the polling trigger indicating the meter itself comes.

In this case, if a channel is idle (“idle” in S604), the transmission unit 211 transmits data (S606). Further, if the channel is busy (“busy” in S604), the transmission unit 211 waits for a next polling trigger indicating the meter itself.

The above processing completes the processing performed by the transmission unit 211 to transmit data in the concentrated control period (S416 in FIG. 16).

Next is a description of a scenario executed by the power-consumption collecting system in Embodiment 2 of the present invention.

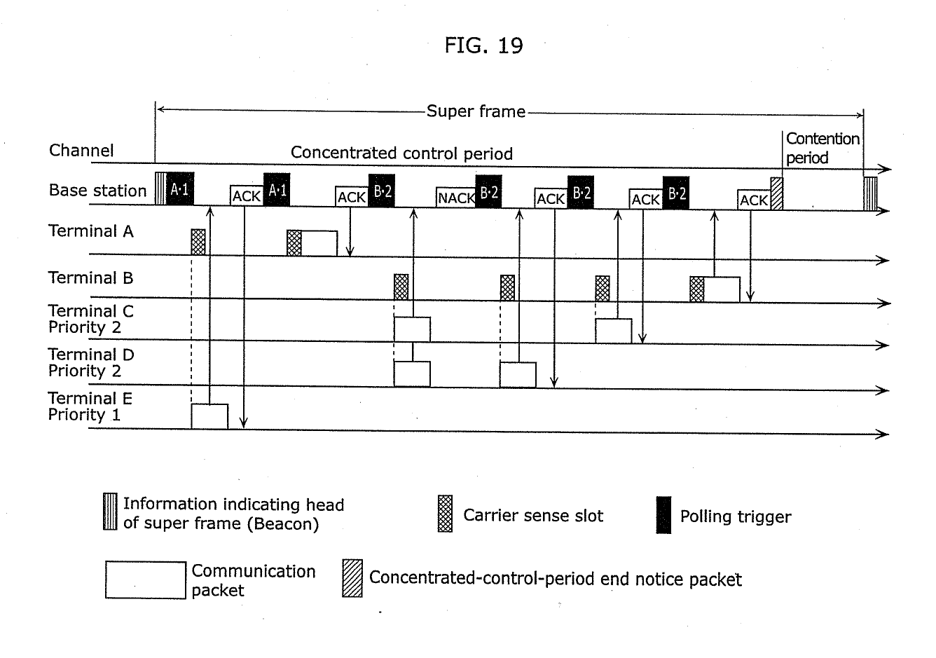

FIG. 19 illustrates the scenario executed by the power-consumption collecting system in Embodiment 2 of the present invention.

In this scenario, when the receiving unit 112 detects a collision of data pieces transmitted from the power meters 2 with a device control function, the management packet generation unit 100 obtains a collision priority index that is a priority index of the data pieces that have collided, and generates a management packet for the period after the collision has been detected using the obtained collision priority index as a priority index included in the management packet for the period after the collision has been detected.

As shown in FIG. 19, the configuration in the scenario includes a base station (the power-consumption-information collecting apparatus 1), and Terminals A, B, C, D, and E (the power meters 2 with a device control function).

The base station notifies all the terminals of the start of the concentrated control period with a beacon. Terminals A and B are terminals that succeeds in making polling reservation. Although Terminals C, D, and E are terminals that fail in making polling reservation, Terminals C and D have transmission data with a priority index 2. Further, Terminal E has transmission data with a priority index 1. The order of terminals on the polling list managed by the base station is Terminals A and B.

After transmitting a beacon, with reference to the polling list, the base station generates a polling trigger packet indicating Terminal A, and also sets a priority index for which interruption is allowed to 1, and then, transmits the polling trigger. It should be noted that the base station in Embodiment 2 of the present invention can dynamically set a priority index for which interruption is allowed for a polling trigger packet, as with the base station in Embodiment 1 of the present invention.

Upon receiving the polling trigger packet, Terminal E detects that the priority index for which interruption is allowed described in the polling trigger is equal to the priority index of transmission data of the terminal itself, judges that the polling trigger is an interrupt trigger, and transmits data.

Although Terminal A receives the polling trigger indicating the terminal itself, Terminal A detects that a channel is busy by performing carrier sense before transmitting data in accordance with the algorithm for transmission in the concentrated control period described above, and cancels transmission of the data. Accordingly, data with a priority index 1 of Terminal E can be transmitted, without colliding with the data of Terminal A.

The base station transmits the polling trigger packet to Terminal A again, after transmitting an ACK packet to Terminal E in response. It should be noted that, although the priority index for which interruption is allowed is set to 1 in FIG. 19, the base station can dynamically set the priority index, and thus may set a priority index other than 1.

Then, an interrupt packet is not generated since the priority index for which interruption is allowed is 1, and thus Terminal A can transmit data after performing carrier sense.

Next, the base station generates a polling trigger packet indicating Terminal B, and sets the priority index for which interruption is allowed to 2, and transmits the polling trigger. Terminals D and E receive the polling trigger, judge that the polling trigger is an interrupt trigger indicating the terminals themselves, and immediately transmit data. At this time, a collision of packets occurs since Terminals D and E transmit data at the same time.

The base station detects the collision of packets with a priority index 2 for which interruption is allowed, and after transmitting a NACK packet, transmits the polling trigger packet including a priority index 2 for which interruption is allowed to Terminals C and D again.

Terminals C and D are notified that the packets that the terminals themselves transmitted have collided by receiving the NACK packet, and introduce the packet collision avoidance algorithm before transmitting data, in order to avoid packet collision from repeatedly occurring.

For the packet collision avoidance algorithm, the packet collision avoidance algorithm described in Embodiment 1 of the present invention may be used. For example, it can be considered that p-persistent or the like may be used as the packet collision avoidance algorithm. For example, Terminals C and D each generate a random number, and if the random number generated by Terminal C is smaller than a specific value p, data is transmitted based on a next interrupt trigger. Further, if the random number generated by Terminal D is greater than the specific value p, a packet is transmitted. Accordingly, only Terminal D transmits a packet, and thus a packet collision can be avoided.

After receiving the packet from Terminal D, the base station transmits an ACK packet, and also transmits a polling trigger. This polling trigger includes information indicating a polling terminal ID “B” and a priority index “2” for which interruption is allowed.

Here, since the base station has detected that a packet collision occurred based on the previous polling trigger, it can be seen that at least two terminals hold data with a priority index 2. Accordingly, by designating a priority index “2” for which interruption is allowed in succession, a chance is given to transmit the remaining data with a priority index “2”.

Terminal C receives a polling trigger, judges that the trigger is an interrupt trigger indicating the terminal itself, and thus transmits data. Then, the base station transmits a polling trigger packet including information indicating Terminal B and a priority index “2” for which interruption is allowed, after transmitting ACK to Terminal C.

Terminal B executes carrier sense for one slot, and thereafter detects that the channel is idle, and thus transmits data. Since the last terminal on the polling list has been reached, and there is no interrupt terminal, the base station transmits a concentrated-control-period end notice packet after transmitting ACK to Terminal B, and notifies the terminals of the start of the contention period.

According to this configuration, when high priority data is generated in a terminal, it is determined, using the transmission period judgment algorithm, whether to perform interrupt transmission of a priority data in the concentrated control period, based on the priority and an allowable delay of data. When it is determined that interrupt transmission is to be performed in the concentrated control period, data is transmitted in a GTS period with the same priority index as that of transmission data, using the algorithm for interrupt transmission in the concentrated control period. A terminal that transmits data in the concentrated control period in a normal manner can prevent a packet collision with data from an interrupt terminal by performing carrier sense before transmission, and thus allows high priority data to be preferentially transmitted. Further, when a collision of packets from interrupt terminals occurs, a collision of the packets from the interrupt terminals can be avoided, by using the collision avoidance algorithm. Furthermore, the base station specifies the priority index of the packets that have collided, and dynamically designates the priority index for which interruption is allowed in a polling trigger, thereby enabling high priority data to be preferentially transmitted.

It should be noted that when the receiving unit 112 has detected a collision of data pieces transmitted from a plurality of terminals and when a collision priority index that is the priority index of the data pieces that have collided is not the highest priority index that indicates the highest priority, the management packet generation unit 100 may generate a management packet for a period after the detection of the collision such that the highest priority index to the collision priority index are repeated, as the priority index included in the management packet for the period after the detection of the collision.

For example, in FIG. 19, when a collision of packets from Terminals D and E occurs, the collision priority index is “2”, and the highest priority index is “1”, and thus the base station sets the priority index for which interruption is allowed after the packet collision occurs in a manner such that the priority indexes are repeated, namely, “1”, “2”, “1”, “2”. Accordingly, the base station can receive the packets that are from Terminals D and E and that have collided, and can also receive data whose priority is higher than that of the packets.

### Embodiment 3

The judgment unit 200 of each communication terminal apparatus in Embodiments 1 and 2 described above compares a priority index included in a received management packet with a priority index of data that the apparatus itself is to transmit, and when the priority indicated by the priority index of the data that the apparatus itself is to transmit is greater than or equal to the priority indicated by the priority index included in the management packet, the judgment unit 200 judges that the apparatus itself has obtained permission to transmit data, and when it is judged that the apparatus itself has obtained permission to transmit data, the transmission unit transmits that data. However, in Embodiment 3 of the present invention, a priority is set in advance for a high priority event (notification data or control command), a specific short signal (hereinafter, referred to as a short-term signal) is assigned to each event for which a priority has been set, and only such a short-term signal that is an extremely short signal is transmitted, instead of a normal wireless-communication packet, thereby enabling a band to be effectively utilized.

Accordingly, a communication terminal apparatus transmits a short-term signal set in advance, when high priority data set in advance is generated, and the judgment unit 200 of the communication terminal apparatus judges that the apparatus itself has obtained transmission permission based on the priority index of the transmission data and contents of a management packet. Since a short-term signal is a signal that needs a short time to be transmitted, the time to transmit a short-term signal is shorter than the carrier sense time of another communication terminal apparatus when the carrier sense time of the other communication terminal apparatus is sufficiently long, and thus the other communication terminal apparatus that performs carrier sense judges that the carrier is not used, which allows transmission to be started. Accordingly, the communication apparatus can receive priority data or a short-term signal, and data from a communication terminal apparatus that has obtained transmission permission based on terminal identification information.

Further, the power-consumption collecting system needs to be aware of a change in energy consumption in real time, and power consumption will be advantageously controlled by associating a priority index with the amount of change in power consumption. Specifically, in an isolated operation mode in which power to be consumed is supplied only from a battery, when power consumption exceeds the rated output of the battery, the output thereof is stopped in order to protect the battery, and thus the energy for the whole system is interrupted. Accordingly, the power-consumption-information collecting apparatus 1 needs to monitor the output of the battery in real time, and control power consumption of home appliances according to the output level.

On the other hand, when the system is operated in a cooperative operation mode in which power to be consumed is supplied from a battery and a power system, the power that exceeds the output of the battery can be purchased from the power system, and thus the monitoring of the output of the battery is not important for the power-consumption-information collecting apparatus 1. Instead, the power-consumption-information collecting apparatus 1 needs to monitor power consumption of other devices, in order to prevent total power consumption from exceeding a limit value.

Accordingly, with a priority index being associated with the amount of change in power consumption, a priority index for which interruption is allowed is designated according to the operating state of the power-consumption collecting system, namely, “in the isolated operation or cooperative operation mode” and the current power consumption of the system and power that can be used (limit value), thereby enabling the power-consumption-information collecting apparatus 1 to quickly obtain necessary data according to the state. The following is a description of an example of a method for calculating a priority index using Expression 1.

Priority index=lowest priority index−power change amount×influence coefficient (Expression 1)

Here, in the present embodiment that the smaller the value of a priority index is, the higher the priority is. Therefore, the lowest priority index is the greatest value that the value of the priority index can be. Further, a power change value is a value indicating a change in power consumed when a specific event occurs. Examples of the power change value includes a value of power purchased from the power system when the output of a battery stops (the output before the stop), power consumed when a home appliance changes its operation mode, and the like. Further, an influence coefficient is a coefficient that indicates the influence on the system due to a change in power consumption.

With Expression 1 above, an influence coefficient is multiplied by a power change value, thereby achieving conversion to a priority index. Accordingly, a priority index is determined based on a power change value. The greater the power change value is, the higher a priority is, thereby enabling more preferential reception.

Specifically, the power-consumption-information collecting apparatus 1 calculates a power change value in a specific operation mode of each home appliance and under a specific setting condition thereof, using an operation mode and a setting condition thereof in the past, and power consumed thereby at that time. For example, a priority index is calculated in accordance with Expression 1 above using the power consumed when a cleaner shifts from the power OFF mode to the power ON mode, as a power change value.

Then, the power-consumption-information collecting apparatus 1 transmits, to the cleaner, information including the priority index obtained using Expression 1 above, an event (a shift from the power OFF mode to the power ON mode), and a short-term signal that is a specific short signal, and instructs the cleaner to transmit the designated priority index and the short-term signal when the corresponding event occurs.

It should be noted that the power-consumption-information collecting apparatus 1 can notify in advance home appliances of a method for calculating a priority index associated with a change in power consumption, instead of designation of an event and a priority index, and thus each appliance can calculate the power change amount caused each time the operation mode of the appliance itself changes, and independently set a priority index. For example, when a storage battery stops its output, a home appliance calculates the power change amount according to the output before and after the stop, and independently calculates a priority index. Accordingly, the notification of the event is preferentially transmitted, as the power change amount is greater due to the stop of the output of the storage battery.

Here, in the configuration of the power-consumption collecting system (the power-consumption-information collecting apparatus 1 and the power meters 2 with a device control function) in Embodiment 3 of the present invention, the same numerals are used for the same configuration as that of the power-consumption collecting system in Embodiment 1 above, and a description thereof is omitted or simplified. Specifically, a description of the configurations of “the communication processing unit 110 of the power-consumption-information collecting apparatus 1, and the judgment unit 200 and the receiving unit 212 of the communication processing unit 210 of the power meters 2 with a device control function” is omitted, and “a management packet generation unit and a transmission unit (transmission control unit)” including new constituent elements will be described below.

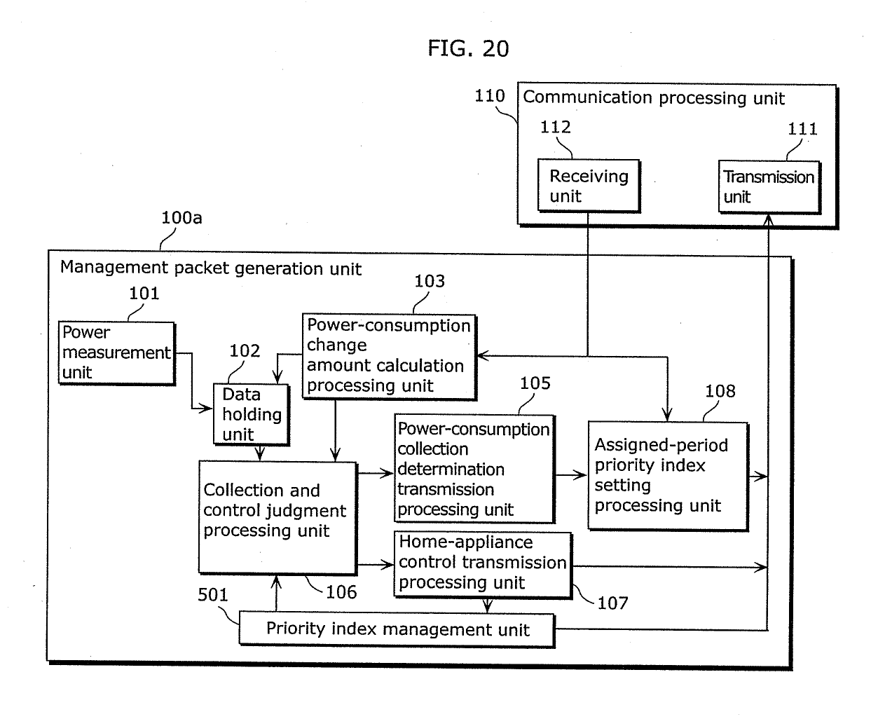

FIG. 20 shows the configuration of a management packet generation unit 100a in Embodiment 3 of the present invention. In FIG. 20, the same numerals are used for the same constituent elements as those in FIG. 3, and a description thereof is omitted or simplified. In FIG. 20, the constituent element newly added is a priority index management unit 501.

When an event set by the home-appliance control transmission processing unit 107 and a priority index for the event are received, the priority index management unit 501 generates priority index management information by assigning a short-term signal that is a specific short signal to a corresponding event, and stores the generated information. Here, such an event corresponds to terminal data held by a power meter 2 with a device control function that is a communication terminal apparatus, as information that indicates the state of a device controlled by the power meter 2 with a device control function.

Specifically, the priority index management unit 501 calculates a priority index by subtracting, from the lowest priority index that is the greatest priority index number and indicates the lowest priority, a value obtained by multiplying the amount of change in power consumed when a device controlled by the power meter 2 with a device control function performs an operation indicated by terminal data (event) by a predetermined coefficient, as shown by Expression 1 above.

Then, the priority index management unit 501 stores, as a priority index management table 501a described below, priority index management information in which terminal data held by a power meter 2 with a device control function, a priority index that indicates the priority of the terminal data, and a short-term signal for identifying the terminal data are associated with one another.

Further, the priority index management unit 501 transmits the priority index management table 501a to the power meter 2 with a device control function involving an event via the transmission unit 111. Specifically, the transmission unit 111 transmits the priority index management table 501a to the power meter 2 with a device control function that holds the terminal data.

When receiving a short-term signal from the receiving unit 112, the collection and control judgment processing unit 106 specifies an event that has occurred, with reference to the priority index management table 501a held by the priority index management unit 501.

Further, when the receiving unit 112 detects a collision of short-term signals transmitted from the power meters 2 with a device control function, the management packet generation unit 100a obtains a collision priority index that is a priority index of the short-term signals that have collided, and generates a management packet for the period after the detection of the collision, using the obtained collision priority index as the priority index included in the management packet for the period after the detection of the collision.

When a first communication terminal apparatus indicated by terminal identification information is permitted to transmit data in a predetermined period, and when a second communication terminal apparatus holds terminal data with a priority for which transmission in the predetermined period is permitted, the receiving unit 112 receives a short-term signal for identifying the terminal data from the second communication terminal apparatus in a short-term period preceding a transmission period in which data is transmitted from the first communication terminal apparatus, the short-term period being included in the predetermined period. Here, each of the first and second communication terminal apparatuses is one of the power meters 2 with a device control function.

Further, the receiving unit 112 receives data from the first communication terminal apparatus in the predetermined period, after receiving the short-term signal from the second communication terminal apparatus in the short-term period. Further, the receiving unit 112 detects a collision of short-term signals transmitted from a plurality of communication terminal apparatuses.

The transmission unit 111 transmits a control signal to a power meter 2 with a device control function that is a control target and determined from terminal data identified using a short-term signal. Specifically, when the receiving unit 112 receives a short-term signal, the transmission unit 111 transmits a control signal to a power meter 2 with a device control function that is a control target and determined from terminal data associated with the short-term signal, with reference to the priority index management table 501a.

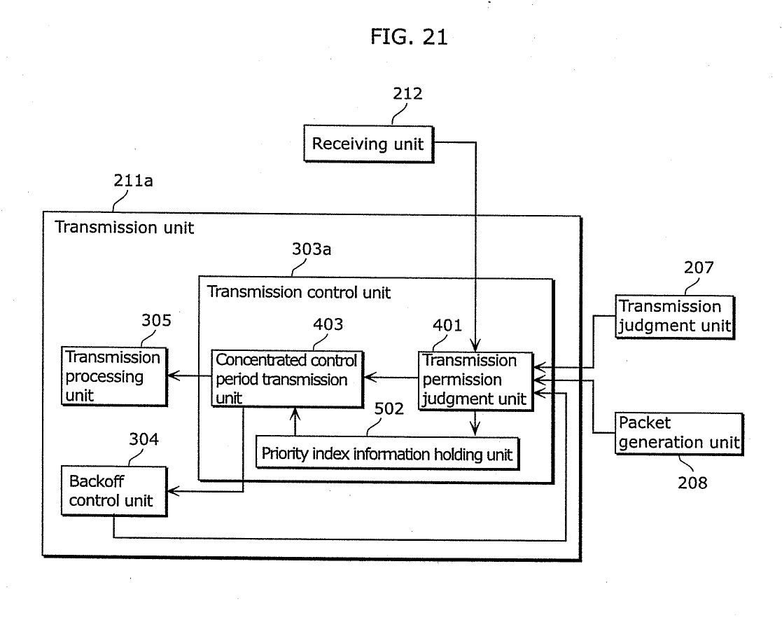

FIG. 21 shows the configuration of a transmission control unit 303a in Embodiment 3 of the present invention. In FIG. 21, the same numerals are used for the same constituent elements as those in FIG. 7, and a description thereof is omitted or simplified. In FIG. 21, the constituent element newly added is a priority index information holding unit 502.

The priority index information holding unit 502 receives, from the transmission-permission judgment unit 401, the priority index management table 501a indicating information regarding a priority index notified by the power-consumption-information collecting apparatus 1 that is a communication apparatus, namely, “details of an event, a priority of the event, and a specific short-term signal assigned to the event”, and holds the received table.

The receiving unit 212 receives the priority index management table 501a from the power-consumption-information collecting apparatus 1, and causes the priority index information holding unit 502 to store the received priority index management table 501a. Specifically, the receiving unit 212 delivers information regarding a priority received from the communication apparatus to the transmission-permission judgment unit 401, and the transmission-permission judgment unit 401 judges whether transmission is possible, based on the information regarding the priority, and also stores the information regarding the priority in the priority index information holding unit 502.

The judgment unit 200 compares a priority index included in a management packet received by the receiving unit 212 with a priority index of data that the meter itself is to transmit, and judges that the meter itself has obtained permission to transmit data, when a priority indicated by the priority index of the data that the meter itself is to transmit is greater than or equal to a priority indicated by the priority index included in the management packet.

When it is judged that the meter itself has obtained permission to transmit data, a transmission unit 211a transmits a short-term signal for identifying terminal data that is data with the priority indicated by the priority index, to the communication apparatus. Thus, the transmission unit 211a transmits a short-term signal associated with the terminal data to the communication apparatus, with reference to the priority index management table 501a.

Specifically, when a transmission permission is obtained from the transmission-permission judgment unit 401 according to a priority index, the concentrated-control-period transmission unit 403 of the transmission unit 211a transmits a short-term signal, with reference to the priority index management table 501a stored in the priority index information holding unit 502.

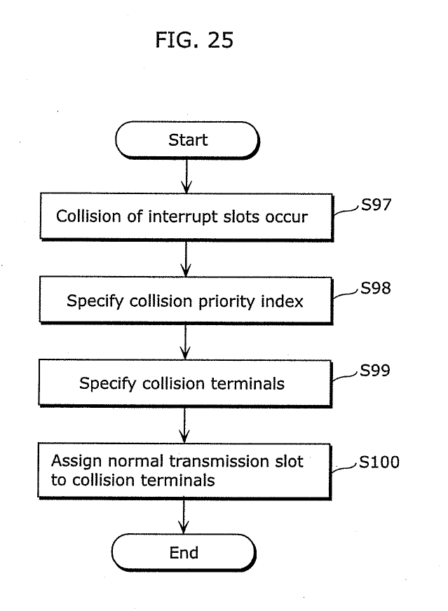

FIG. 25 shows an example of the priority index management table 501a in Embodiment 3 of the present invention. As shown in the drawing, the priority index management table 501a is a collection of information pieces in each of which terminal data (event) held by a power meter 2 with a device control function, a priority index that indicates the priority of the terminal data, and a short-term signal for identifying the terminal data are associated with one another.

Here, terminal data is information that indicates the state of a home appliance controlled by a power meter 2 with a device control function. Thus, a home appliance is determined as being a control target based on the terminal data, and the power-consumption-information collecting apparatus 1 transmits a control signal to the corresponding power meter 2 with a device control function, so as to control the home appliance.

Further, a short-term signal is a signal that needs a short time to be transmitted and is determined in correspondence with such terminal data. Such a short-term signal is a specific short signal, such as a 4-byte preamble sequence included in a packet, for example.

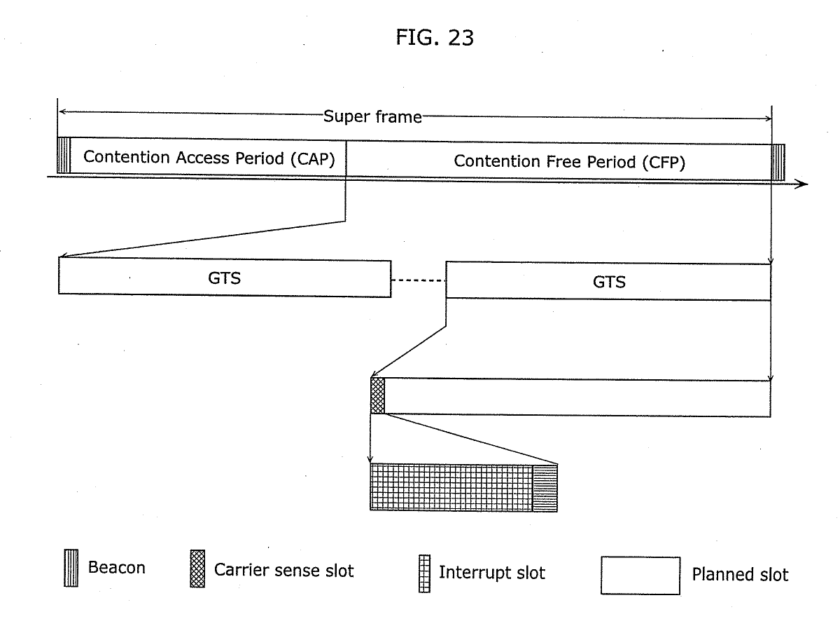

FIG. 23 shows a frame structure of a wireless communication system in Embodiment 3 of the present invention. The present embodiment describes another configuration as a result of applying the present invention to the 802.15.4 standard.

As shown in FIG. 23, in the present embodiment, a channel is divided into a contention period (CAP) and a concentrated control period (CFP), as with the case of the super frame in compliance with the 802.15.4 standard. In the contention period, terminals (the power meters 2 with a device control function) communicate, using a decentralized autonomous multiplex communication system, namely, slotted CSMA/CA, for example.

Further, when a terminal desires to transmit data in the concentrated control period, the terminal makes a request to the base station (the power-consumption-information collecting apparatus 1) in the contention period. The base station transmits, in response, the result indicating whether or not transmission is permitted to the terminal that made a request. The following is a description of priority control in the concentrated control period, which is a feature of the present invention.

The concentrated control period includes a plurality of assignment periods (guaranteed time slots/GTSs), and furthermore, one carrier sense slot is provided in the head of each GTS. The time excluding the carrier sense slot in a GTS is a planned slot.

The length of a carrier sense slot needs to be longer than the time necessary to transmit a short-term signal that is a specific short signal (interrupt slot).

The communication apparatus periodically transmits beacons. Here, information in each beacon includes at least “the number of GTSs, the length of each GTS, a start time slot, an ID of an assigned terminal, and a priority index of data that can be transmitted other than the data of the assigned terminal”, which indicates the length of a super frame (the number of time slots), the start time slot of the concentrated control period (CFP), and GTS assignment information.

Next is a description of processing performed by the power-consumption-information collecting apparatus 1 in Embodiment 3 of the present invention.

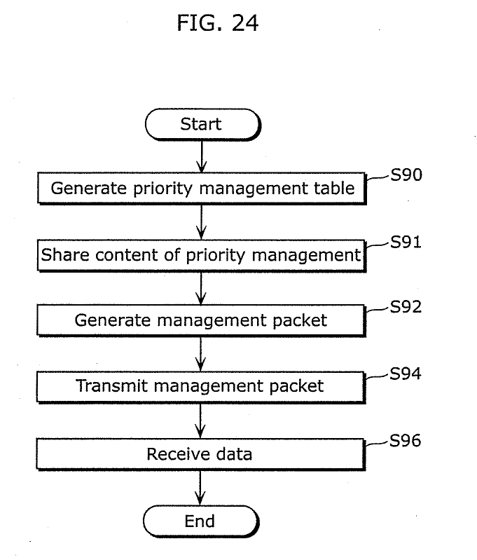

FIG. 24 is a flowchart showing an example of processing performed by the power-consumption-information collecting apparatus 1 in Embodiment 3 of the present invention. In FIG. 24, the same numerals are used for the steps in which the same processing as that in FIG. 9 is performed, and a description thereof is omitted or simplified.

As shown in FIG. 24, first, the priority index management unit 501 of the management packet generation unit 100a generates the priority index management table 501a in which priorities and contents in specific short-term signals are described with respect to high priority events, respectively (S90).

Then, the transmission unit 111 transmits the content of the priority index management table 501a to a related power meter 2 with a device control function (S91).

Next, the management packet generation unit 100a generates a management packet that includes terminal identification information that indicates a power meter 2 with a device control function permitted to transmit data in a predetermined period, and a priority index of data permitted to be transmitted in the predetermined period (S92).

Then, the transmission unit 111 transmits the management packet generated by the management packet generation unit 100a to all the power meters 2 with a device control function (S94). Then, the receiving unit 112 receives data in the predetermined period from a power meter 2 with a device control function determined from the terminal identification information and the priority index (S96).

Next is a description of collision avoidance processing performed by the power-consumption-information collecting apparatus 1 in Embodiment 3 of the present invention.

FIG. 25 is a flowchart that shows an example of collision avoidance processing performed by the power-consumption-information collecting apparatus 1 in Embodiment 3 of the present invention.

As shown in FIG. 25, the receiving unit 112 of the power-consumption-information collecting apparatus 1 detects occurrence of a collision of interrupt slots, which are short-term signals transmitted from the power meters 2 with a device control function (S97).

Then, the management packet generation unit 100a specifies a collision priority index that is a priority index of the short-term signals that have collided (S98), and specifies collision terminals from the specified collision priority index, with reference to the priority index management table 501a (S99).

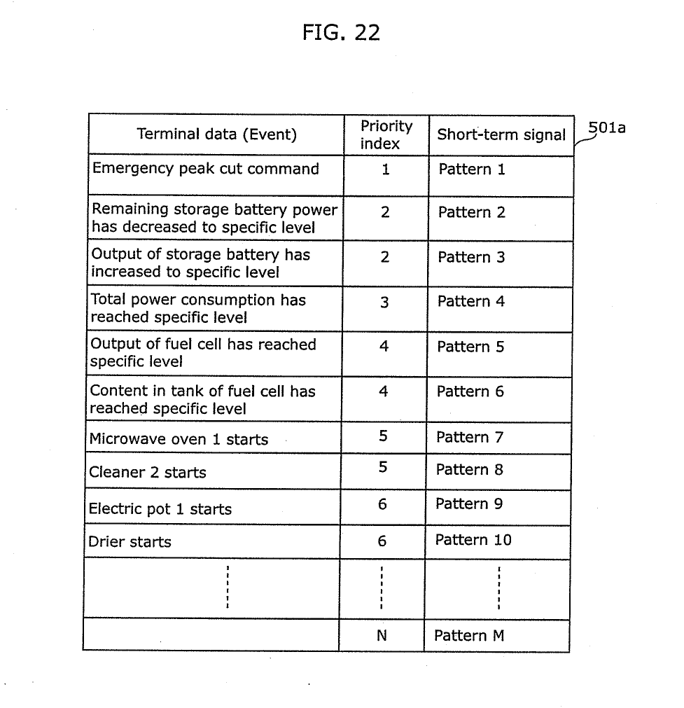

Specifically, for example, a priority index 6 is assigned to two events, namely, “electronic pot 1 starts” and “drier starts” in the priority index management table 501a shown in FIG. 22, and thus if both events occur at the same time, a collision of data pieces with the priority index occur due to the data being transmitted at the same time. Thus, the management packet generation unit 100a specifies the electronic pot 1 and the drier as being collision terminals.

Then, the management packet generation unit 100a assigns a slot to both of the collision terminals in the generation of a next management packet, using the specified collision priority index as a priority index included in the management packet (S100). Accordingly, a collision can be avoided.

Next is a description of processing performed by the power meters 2 with a device control function in Embodiment 3 of the present invention.

It should be noted that with regard to the processing performed by the power meters 2 with a device control function in Embodiment 3 of the present invention, the same numerals are used for the same processing as the processing performed by the power meters 2 with a device control function in Embodiment 1 above, and a description thereof is omitted or simplified. Specifically, a description of processing for “the transmission period judgment algorithm (FIG. 10) and the algorithm for transmission in the concentrated control period (FIG. 12)” is omitted, and “the algorithm for interrupt transmission in the concentrated control period” including new processing will be described.

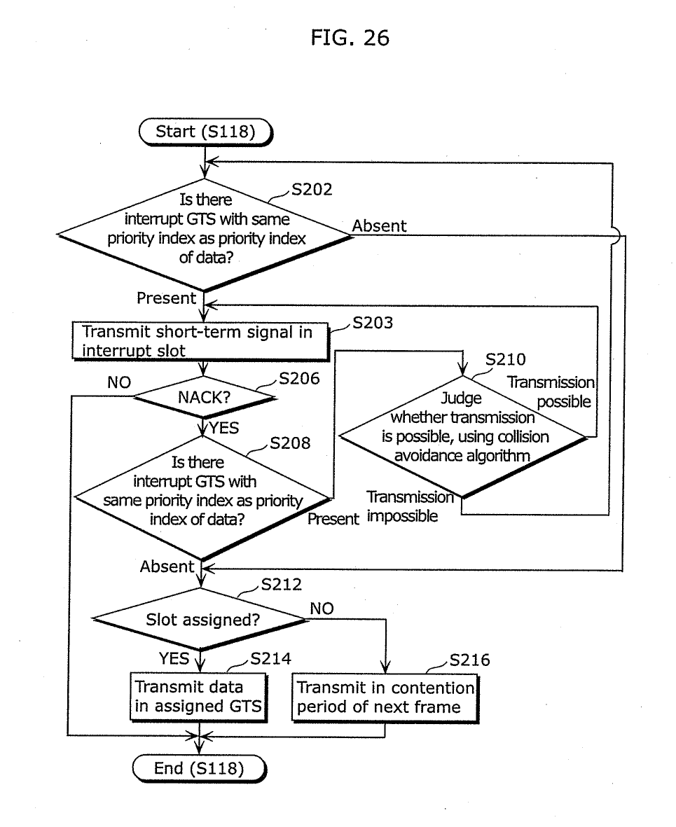

FIG. 26 is a flowchart for describing the algorithm for interrupt transmission in the concentrated control period performed by the power meters 2 with a device control function in Embodiment 3 of the present invention. With regard to the processes in FIG. 26, the same numerals are used for the same processing as that in FIG. 11, and a description thereof is omitted or simplified. Specifically, instead of processing for transmitting data in an interrupt GTS (S204 in FIG. 11), a short-term signal is transmitted in an interrupt slot (S203).

Specifically, first, the transmission unit 211a of a power meter 2 with a device control function that performs interrupt transmission judges, with reference to information in a beacon, whether or not there is an assignment period that is assigned to another apparatus and has the same priority index as the priority index of data that the meter itself is to transmit (hereinafter, referred to as interrupt GTS) (S202).

When judging that there is an interrupt GTS (“present” in S202), the transmission unit 211a immediately transmits a short-term signal in the interrupt slot (S203). Other processing to be performed thereafter is the same as that in FIG. 11.

According to this configuration, when high priority data is generated in a power meter 2 with a device control function, it is determined, using the transmission period judgment algorithm (FIG. 10) in Embodiment 1 of the present invention, whether or not to perform interrupt transmission of a short-term signal corresponding to the priority data in the concentrated control period, based on the priority and allowable delay of the data. When it is determined that interrupt transmission is to be performed in the concentrated control period, a short-term signal corresponding to an event determined in advance is transmitted in an interrupt slot in a GTS period with the same the priority index as that of transmission data, using the algorithm for interrupt transmission in the concentrated control period. Although a power meter 2 with a device control function that transmits data in the concentrated control period in a normal manner performs carrier sense before the transmission, the interrupt slot is shorter than the carrier sense slot, and thus the power meter can judge that a carrier is not used, and transmit data.

It should be noted that although a power meter 2 with a device control function that transmits data in the concentrated control period in a normal manner performs carrier sense before the transmission in the present embodiment, it is not necessary to perform carrier sense since an interrupt slot is shorter than the carrier sense slot. Specifically, data may be transmitted in a planned slot in FIG. 23, without performing processing in S304 in FIG. 12. Further, although a carrier sense slot is set at the head of a GTS, a carrier sense slot may be set at the end of a GTS.

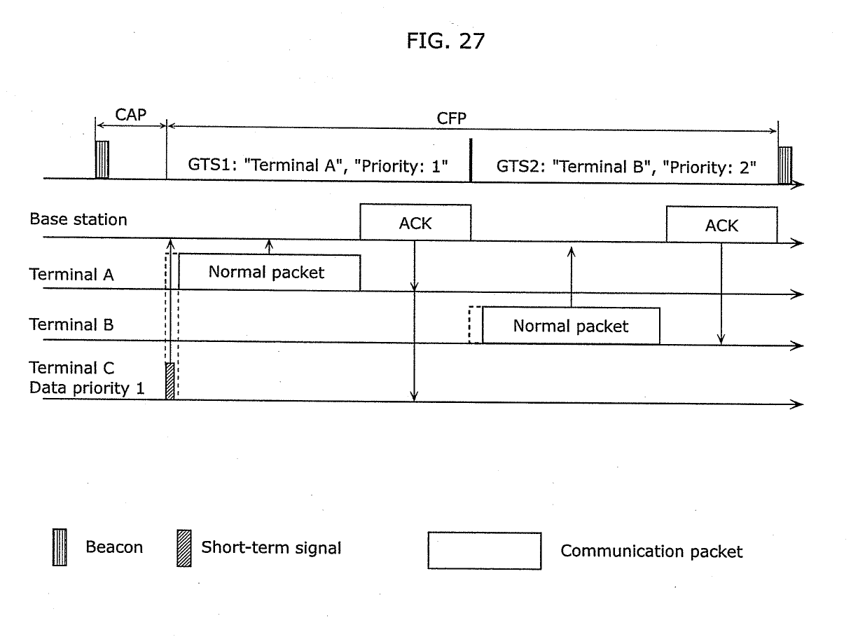

The following is a description of details of scenarios executed by the power-consumption collecting system in Embodiment 3 of the present invention, with reference to FIGS. 27 to 31.

FIG. 27 illustrates Scenario 1 executed by the power-consumption collecting system in Embodiment 3 of the present invention.

In Scenario 1, the receiving unit 112 receives a short-term signal from one communication terminal apparatus in a predetermined period, and thereafter receives data from another communication terminal apparatus.

As shown in FIG. 27, the configuration in the scenario includes a base station (the power-consumption-information collecting apparatus 1), and Terminals A, B, and C (the power meters 2 with a device control function).

The base station assigns GTS1 to Terminal A, and GTS2 to Terminal B, using a beacon. Furthermore, the base station sets a priority index for which interruption is allowed to 1 for GTS1, and 2 for GTS2.

In this way, the base station generates a management packet including terminal identification information pieces and priority indexes respectively corresponding to two or more GTS periods, and transmits the management packet to the terminals. Further, Terminal C does not have an assigned GTS, but has transmission data with a priority index 1.

Terminal C judges, with reference to information in the beacon, that a priority index for which interruption is allowed of GTS1 is the same as the priority index of transmission data of the terminal itself, and immediately transmits a specific short-term signal corresponding to an event determined in advance, when a super frame comes to the position of GTS1.

Terminal A performs carrier sense for one time slot before transmitting data when the super frame comes to the position of GTS1 assigned to the terminal itself. Although Terminal A detects, while performing carrier sense, that a channel is temporarily busy, due to transmission of a short-term signal from Terminal C, the time for Terminal C to transmit the signal is shorter than the time for carrier sense, and thus Terminal A detects that the channel is idle, upon the end of transmission by Terminal C, and is allowed to transmit data.

Therefore, the base station can receive a short-term signal corresponding to high priority data and data from the assigned terminal in the same GTS, which can reduce transmission delay and achieve high channel utilization.

Since there is no interrupt data in GTS2 next, Terminal B detects that the channel is idle after performing carrier sense, and transmits data.

It should be noted that the same effect can be obtained, even if Terminals A and B do not perform carrier sense, but transmit data in a planned slot. Further, for example, Terminal A may transmit data immediately after Terminal C completes transmitting a short-term signal, without waiting for the time for carrier sense to elapse.

As described above, according to the power-consumption-information collecting apparatus 1 in Embodiment 3 of the present invention, a short-term signal for identifying terminal data with a priority for which transmission in a predetermined period is permitted is received from the second communication terminal apparatus in a short-term period preceding a transmission period in which data is transmitted from the first communication terminal apparatus, and a control signal is transmitted to a communication terminal apparatus that is a control target determined from terminal data identified using the short-term signal. Specifically, the power-consumption-information collecting apparatus 1 can receive a short-term signal for identifying high priority terminal data from the second communication terminal apparatus, in the short-term period preceding the transmission period in which data is transmitted from the first communication terminal apparatus. Accordingly, the power-consumption-information collecting apparatus 1 can receive that short-term signal, without affecting transmission of data in the transmission period. Accordingly, even if there is a communication terminal apparatus that is assigned to transmit data, when high priority data is generated in another communication terminal apparatus, the power-consumption-information collecting apparatus 1 can receive a signal for identifying the high priority data.

Further, after receiving a short-term signal from the second communication terminal apparatus in the short-term period, the power-consumption-information collecting apparatus 1 receives data from the first communication terminal apparatus in the predetermined period. Thus, the power-consumption-information collecting apparatus 1 receives a short-term signal for identifying high priority data from the second communication terminal apparatus, and can also receive data permitted to be transmitted in the predetermined period from the first communication terminal apparatus. Accordingly, when there is the first communication terminal apparatus assigned to transmit data, and when high priority data is generated in the second communication terminal apparatus, the power-consumption-information collecting apparatus 1 can receive information that indicates the high priority data from the second communication terminal apparatus, and can furthermore receive data also from the first communication terminal apparatus.

Further, the power-consumption-information collecting apparatus 1 calculates a priority index by subtracting, from the lowest priority index, a value obtained by multiplying, by a predetermined coefficient, the amount of change in power consumed by a home appliance controlled by a power meter 2 with a device control function. Accordingly, a priority index is calculated such that the greater the power change amount of the home appliance is, the higher the priority is. Accordingly, the power-consumption-information collecting apparatus 1 can preferentially obtain, as information for adjusting power consumption, information on the operation of a home appliance whose power consumption greatly changes.

Further, according to the power meters 2 with a device control function in Embodiment 3 of the present invention, the priority indicated by a priority index of data that a power meter 2 with a device control function is to transmit is greater than or equal to the priority indicated by a priority index included in a management packet, the meter itself judges that the meter has obtained permission to transmit data, and transmits a short-term signal for identifying the data. Accordingly, the power meter 2 with a device control function can transmit, when high priority data is generated in the meter itself, a short-term signal for identifying the high priority data, even if there is another power meter 2 with a device control function assigned to transmit data.

Further, the power meters 2 with a device control function receive the priority index management table 501a from the power-consumption-information collecting apparatus 1, and transmit a short-term signal associated with terminal data to the power-consumption-information collecting apparatus 1, with reference to the received priority index management table 501a. Specifically, the power meters 2 with a device control function can obtain a short-term signal associated with high priority terminal data with reference to the priority index management table 501a received from the power-consumption-information collecting apparatus 1, and thus can transmit the short-term signal associated with the terminal data to the power-consumption-information collecting apparatus 1.

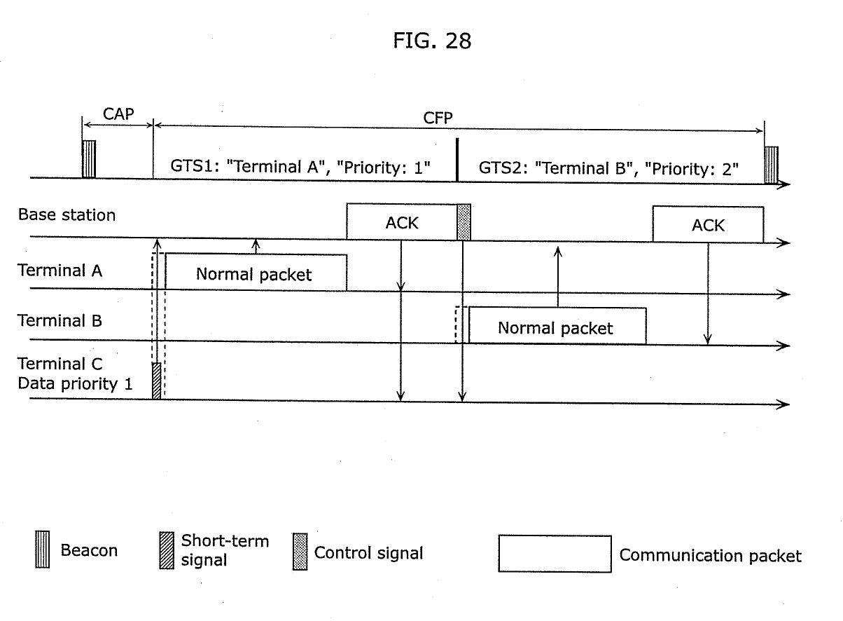

FIG. 28 illustrates Scenario 2 executed by the power-consumption collecting system in Embodiment 3 of the present invention.

In Scenario 2, when the receiving unit 112 receives a short-term signal, the transmission unit 111 transmits a control signal to a communication terminal apparatus that is a control target determined from terminal data associated with the short-term signal, with reference to the priority index management table 501a.

Specifically, as shown in FIG. 28, as with the case of Scenario 1 shown in FIG. 27, the base station receives a short-term signal from Terminal C and also receives data from Terminal A in GTS1. Then, the base station transmits a control signal to a power meter 2 with a device control function that is a control target (Terminal C in FIG. 28) in GTS2 while Terminal B performs carrier sense.

As described above, according to the power-consumption-information collecting apparatus 1 in Scenario 2 when a short-term signal is received, a control signal is transmitted to a power meter 2 with a device control function that is a control target obtained from terminal data associated with the short-term signal, with reference to the priority index management table 501a. Specifically, each power meter 2 with a device control function receives the priority index management table 501a transmitted by the power-consumption-information collecting apparatus 1, and transmits a short-term signal associated with high priority terminal data to the power-consumption-information collecting apparatus 1, with reference to the received priority index management table 501a. Accordingly, the power-consumption-information collecting apparatus 1 can obtain terminal data associated with the received short-term signal, with reference to the priority index management table 501a, and transmit a control signal to the power meter 2 with a device control function that is a control target determined from the obtained terminal data.

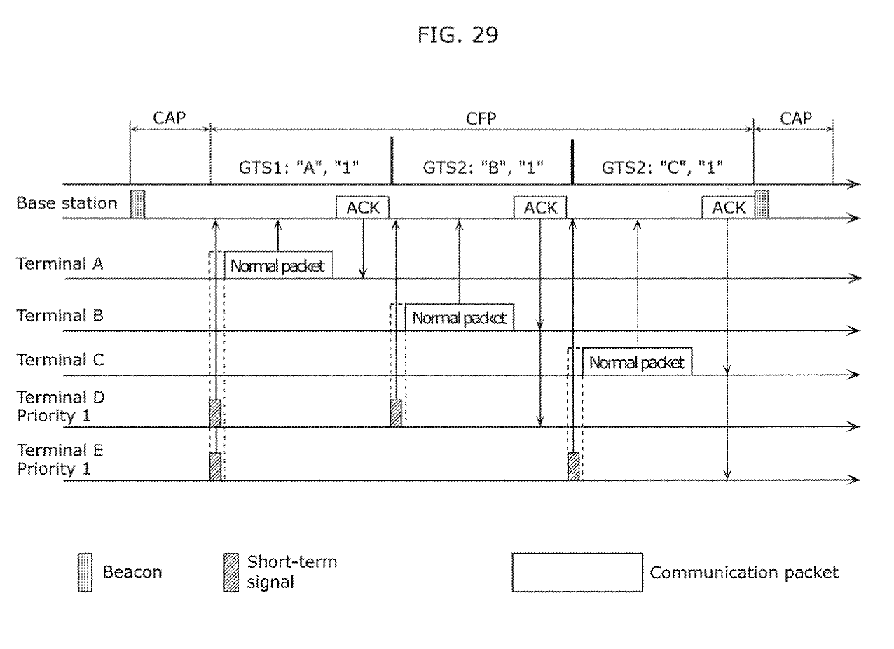

FIG. 29 illustrates Scenario 3 executed by the power-consumption collecting system in Embodiment 3 of the present invention.

As shown in FIG. 29, the configuration in the scenario includes a base station (the power-consumption-information collecting apparatus 1), and Terminals A, B, C, D, and E (the power meters 2 with a device control function).

The base station assigns GTS1 to Terminal A, GTS2 to Terminal B, and GTS3 to Terminal C, using a beacon. Furthermore, the base station sets a priority index for which interruption is allowed to 1 for GTS1, 1 for GTS2, and 1 for GTS3. Terminals D and E do not have an assigned GTS, but have transmission data with a priority index 1.

Terminals D and E judge, with reference to information in the beacon, that a priority index for which interruption is allowed of GTS1 is the same as the priority index of transmission data of the terminals themselves, and each immediately transmit a specific short-term signal corresponding to the event determined in advance when the super frame comes to the position of GTS1.

Terminal A performs carrier sense for one time slot before transmitting data when the super frame comes to the position of GTS1 assigned to the terminal itself. Although Terminal A detects that a channel is temporarily busy due to transmission of the short-term signals from Terminals D and E while performing carrier sense, the time for transmission by Terminals D and E is shorter than the time for carrier sense, and thus Terminal A detects that the channel is idle upon the end of transmission by Terminals D and E, and can transmit data.

Here, since Terminals D and E transmit short-term signals at the same time, a collision of the short-term signals occurs. Accordingly, the base station detects errors in the received short-term signals, and transmits an ACK packet only to Terminal A.

Terminals D and E do not receive an ACK packet addressed to the terminals themselves, and thus judge that a collision of the short-term signals has occurred.

Although Terminals D and E judge, with reference to the information in the beacon again, that the priority index for which interruption is allowed of GTS2 is the same as the priority index of the transmission data of the terminals themselves, Terminals D and E apply a collision avoidance algorithm in GTS2 since the short-term signals transmitted immediately before have collided.

Then, Terminal D judges that transmission is possible, using the collision avoidance algorithm, and transmits a short-term signal. Terminal E judges that transmission is not possible, using the collision avoidance algorithm, and cancels transmission of data. Although Terminal B detects while performing carrier sense, that the channel is temporarily busy due to transmission of a short-term signal from Terminal D, the time for transmission by Terminal D is shorter than the time for carrier sense, and thus upon the end of transmission by Terminal D, Terminal B detects that the channel is idle, and can transmit data.

The base station properly receives the short-term signal from Terminal D, and the packet from Terminal B, and transmits an ACK packet to both terminals.

In GTS3 next, Terminal E judges that transmission is possible, using the collision avoidance algorithm, and transmits a short-term signal. Although Terminal C detects, while performing carrier sense, that the channel is temporarily busy due to transmission of the short-term signal from Terminal E, the time for transmission by Terminal E is shorter than the time for carrier sense, and thus upon the end of transmission by Terminal E, Terminal C detects that the channel is idle, and can transmit data.

According to this configuration, when high priority data is generated in a terminal, using the transmission period judgment algorithm, it is possible to determine whether or not to perform interrupt transmission of a short-term signal corresponding to priority data in the concentrated control period, based on the priority and an allowable delay of the data. When it is determined that interrupt transmission is to be performed in the concentrated control period, a short-term signal is transmitted in a GTS period with the same priority index as that of transmission data, using the algorithm for interrupt transmission in the concentrated control period. Further, when a collision of packets from interrupt terminals occurs, a collision of the packets from the interrupt terminals can be avoided, using the collision avoidance algorithm.

Further, when the priority index for which interruption is allowed of GTS2 or GTS3 is not 1, the base station can receive short-term signals from Terminals D and E by resetting the priority index for which interruption is allowed of GTS2 and GTS3 to 1.

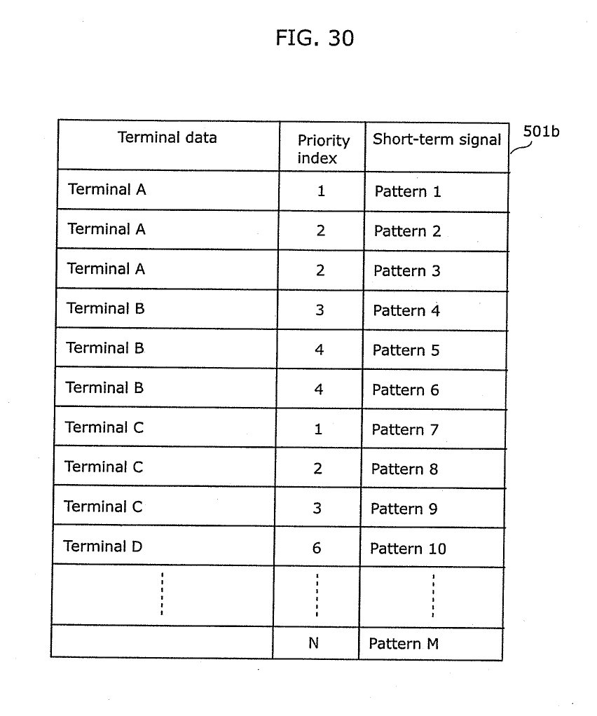

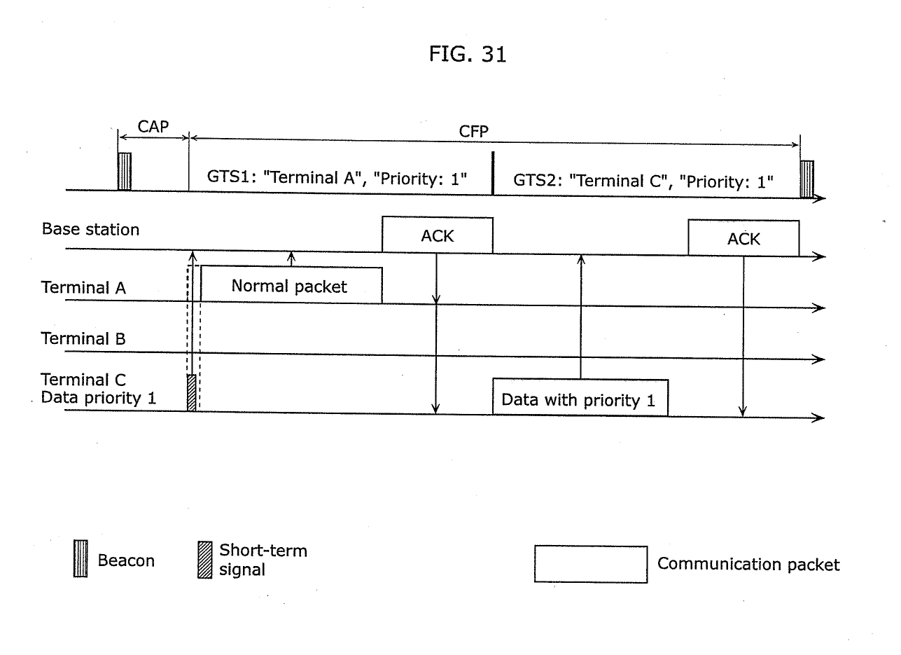

FIGS. 30 and 31 illustrate Scenario 4 executed by the power-consumption collecting system in Embodiment 3 of the present invention.

In Scenario 4, the priority index management unit 501 stores a priority index management table 501b in which information indicating a communication terminal apparatus that holds terminal data is associated with a priority index and a short-term signal, as shown in FIG. 30.

When the receiving unit 112 receives a short-term signal, the management packet generation unit 100a permits, with reference to the priority index management table 501b, a second communication terminal apparatus that is a communication terminal apparatus associated with the short-term signal to transmit data in a later period succeeding a predetermined period.

The receiving unit 112 receives terminal data identified using the short-term signal from the second communication terminal apparatus in the later period.

The transmission unit 111 transmits a control signal to a communication terminal apparatus that is a control target and determined from terminal data received by the receiving unit 112.

Specifically, as shown in FIG. 31, the base station receives a short-term signal from Terminal C and data from Terminal A in GTS1, as with the case of Scenario 1 shown in FIG. 27.

Further, in order to receive transmission data with a priority index 1 from Terminal C in GTS2, the base station assigns GTS2 to Terminal C and sets a priority index for which interruption is allowed of GTS2 to 1, using a beacon.

Accordingly, in GTS2, Terminal C can transmit transmission data with a priority index 1, and the base station can receive transmission data with a priority index 1 from Terminal C.

As described above, according to the power-consumption-information collecting apparatus 1 in Scenario 4, when a short-term signal is received, a second communication terminal apparatus (Terminal C) associated with the short-term signal is permitted to transmit data in a later period (GTS2) succeeding the predetermined period (GTS1), and terminal data identified using the short-term signal is received from the second communication terminal apparatus (Terminal C) in the later period (GTS2). Specifically, the power-consumption-information collecting apparatus 1 can receive high priority terminal data identified using a short-term signal, after receiving the short-term signal.

### Embodiment 4

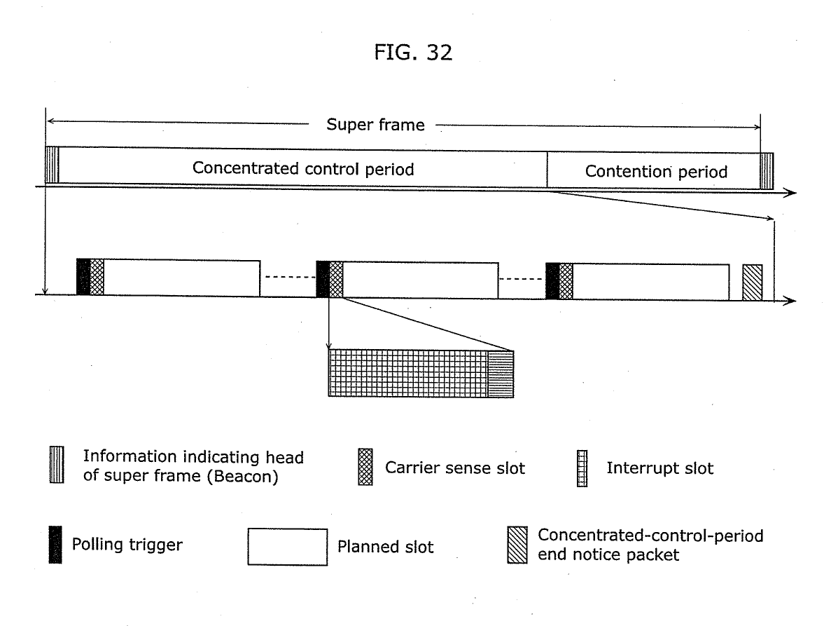

FIG. 32 shows a frame structure of a wireless communication system in Embodiment 4 of the present invention. Embodiment 4 of the present invention describes a configuration in which the present invention is applied to a general polling method, using the same method as that in Embodiment 3, namely, the method of “transmitting a short-term signal in an interrupt slot”. Specifically, the length of a carrier sense slot is longer than the time necessary to transmit a short-term signal (interrupt slot).

As shown in FIG. 32, the super frame in Embodiment 4 includes a concentrated control period and a contention period. The concentrated control period starts from a beacon that is information indicating the head of the super frame, and ends at a concentrated-control-period end notice packet. The concentrated-control-period end notice packet includes at least information on the length of the contention period. The contention period starts from a concentrated-control-period end notice packet and ends at the length described in the concentrated control period end notice packet.

A terminal (a power meter 2 with a device control function) makes polling reservation to the base station (the power-consumption-information collecting apparatus 1) in the contention period, using a decentralized autonomous wireless communication system, for example, CSMA/CA, when data is to be transmitted in the concentrated control period (polling period), as in Embodiment 1.

The base station permits or does not permit the wireless terminal that makes polling reservation to be registered in a polling list, and notifies the wireless terminal of the result. With reference to the result indicating that polling reservation is permitted, the terminal transmits data, using the transmission period judgment algorithm (FIG. 16) in Embodiment 2.

Further, the base station transmits a beacon to terminals, and the beacon notifies the terminals of the start of the concentrated control period. Information on the polling list may be included in the beacon, or notified using a different packet.

Further, the base station does not assign a slot to each terminal, and instead thereof, collects data by notifying a terminal from which data is to be collected of a polling trigger. In other words, the base station transmits a polling trigger in the order of terminals on the polling list. Each polling trigger includes at least an ID of a wireless terminal permitted to transmit data and a priority index for which interruption is allowed.

Specifically, the management packet generation unit 100a of the power-consumption-information collecting apparatus 1 generates, as a management packet, a polling trigger that includes terminal identification information indicating a power meter 2 with a device control function permitted to transmit data in a predetermined period, and a priority index of data for which transmission in the predetermined period is permitted.

It should be noted that the configuration of the power-consumption collecting system (the power-consumption-information collecting apparatus 1 and the power meters 2 with a device control function) in Embodiment 4 of the present invention is the same as the configuration of the power-consumption collecting system in Embodiment 3 above, and thus a detailed description of the configuration is omitted. Further, processing performed by the power-consumption-information collecting apparatus 1 in Embodiment 4 of the present invention is also the same as that of a description in Embodiment 3, and thus a description thereof is omitted.

Further, transmission period judgment processing performed by the power meters 2 with a device control function in Embodiment 4 of the present invention is also the same as the transmission period judgment algorithm in Embodiment 2 of the present invention (FIG. 16), and thus a description thereof is omitted.

Next is a detailed description of processing performed by the transmission unit 211a in Embodiment 4 of the present invention to perform interrupt transmission in the concentrated control period (S418 in FIG. 16).

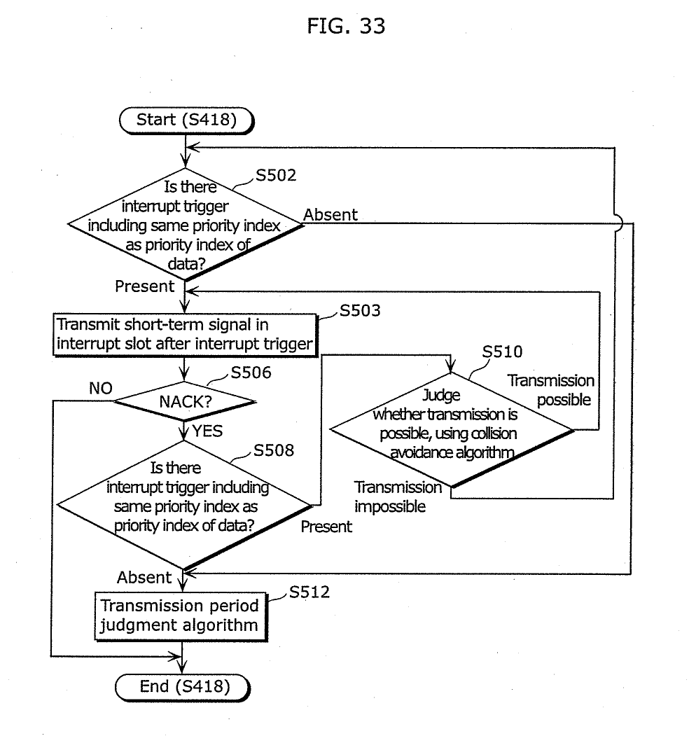

FIG. 33 is a flowchart for describing the algorithm for interrupt transmission in the concentrated control period performed by the power meters 2 with a device control function in Embodiment 4 of the present invention.

In FIG. 33, the same numerals are used for the same processing as that in FIG. 17, and a description thereof is omitted or simplified. Specifically, instead of processing for transmitting data in an interrupt trigger (S504 in FIG. 17), processing for transmitting a short-term signal in an interrupt slot after an interrupt trigger (S503) is performed.

Specifically, first, the transmission unit 211a of a power meter 2 with a device control function that performs interrupt transmission judges, with reference to information in a polling trigger, whether or not there is a polling trigger including the same priority index as that of data that the meter itself is to transmit (hereinafter, referred to as an interrupt trigger) (S502).

When judging that there is an interrupt trigger (“present” in S502), the transmission unit 211a immediately transmits a short-term signal set in advance in correspondence with a priority (event) in the interrupt slot after the interrupt trigger (S503). The other processing to be preformed thereafter is the same as that in FIG. 11.

According to this configuration, when high priority data is generated in a power meter 2 with a device control function, it is determined, using the transmission period judgment algorithm (FIG. 16) in Embodiment 2 of the present invention, whether or not to perform interrupt transmission of a short-term signal corresponding to the priority data in the concentrated control period, based on the priority and an allowable delay of the data. Then, when it is determined that interrupt transmission is to be performed in the concentrated control period, a short-term signal corresponding to an event determined in advance is transmitted using the algorithm for interrupt transmission in the concentrated control period (FIG. 33), based on a polling trigger including the same priority index as that of transmission data. Although a power meter 2 with a device control function that transmits data in the concentrated control period in a normal manner performs carrier sense before transmission, since an interrupt slot is shorter than the carrier sense slot, it can be judge that a carrier is not used, and data can be transmitted.

It should be noted that although a power meter 2 with a device control function that transmits data in the concentrated control period in a normal manner performs carrier sense before transmission in the present embodiment, it is not necessary to perform carrier sense since an interrupt slot is shorter than a carrier sense slot. Specifically, data may be transmitted in a planned slot in FIG. 32 without performing processing in S604 in FIG. 18. Further, although carrier sense slots are set before planned slots, carrier sense slots may be set after planned slots.

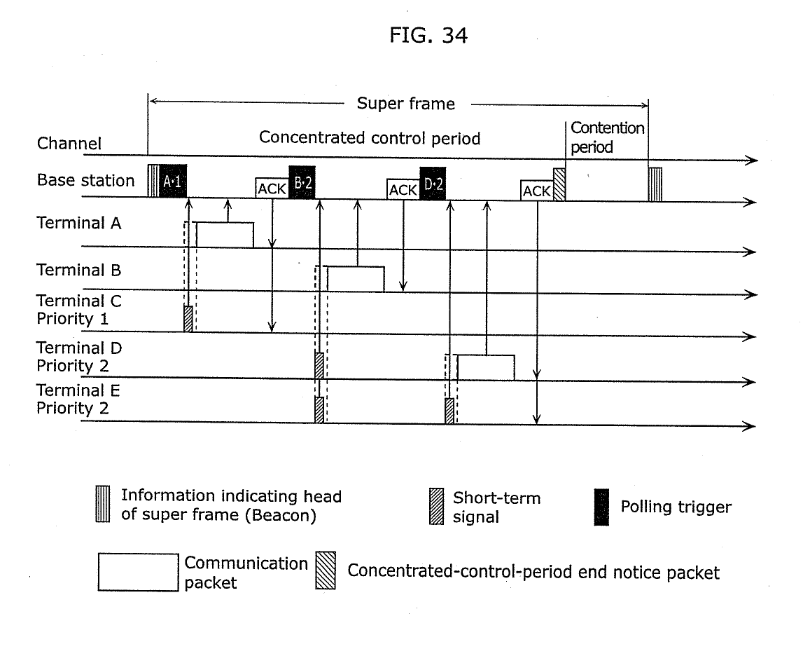

FIG. 34 illustrates a scenario executed by the power-consumption collecting system in Embodiment 4 of the present invention.

In this scenario, when the receiving unit 112 detects a collision of short-term signals transmitted from the power meters 2 with a device control function, the management packet generation unit 100a obtains a collision priority index that is a priority index of the short-term signals that have collided, and specifies the terminals involving the collision, based on the obtained collision priority index.

Further, the management packet generation unit 100a generates a management packet for the period after the detection of the collision using the obtained collision priority index as a priority index included in the management packet for the period after the detection of the collision. Specifically, the management packet generation unit 100a generates a polling trigger packet indicating a terminal involving the collision, and also sets a priority index for which interruption is allowed to the collision priority index, in order to avoid a collision.

As shown in FIG. 34, the configuration in the scenario includes a base station (the power-consumption-information collecting apparatus 1) and Terminals A, B, C, D, and E (the power meters 2 with a device control function).

The base station notifies all the terminals of the start of the concentrated control period with a beacon. Terminals A and B are terminals that succeeds in making polling reservation. Although Terminals C, D, and E are terminals that fail in making polling reservation, Terminal C has transmission data with a priority index 1. Further, Terminals D and E have transmission data with a priority index 2. Further, the order of terminals on the polling list managed by the base station is Terminals A and B.

After transmitting a beacon, with reference to the polling list, the base station generates a polling trigger packet indicating Terminal A, and also sets a priority index for which interruption is allowed to 1, and then transmits the polling trigger. It should be noted that the base station in Embodiment 4 of the present invention can dynamically set a priority index for which interruption is allowed of a polling trigger packet, as with the case of the base station in Embodiment 1 of the present invention.

Upon receiving the polling trigger packet, Terminal C detects that the priority index for which interruption is allowed described in the polling trigger is equal to the priority index of transmission data of the terminal itself, thereby judging that the polling trigger is an interrupt trigger, and transmits a short-term signal set in advance in correspondence with the priority (event) in an interrupt slot after the interrupt trigger.

Terminal A receives the polling trigger indicating the terminal itself, and performs carrier sense before transmitting data, in accordance with the algorithm for transmission in the concentrated control period in Embodiment 2 of the present invention. Although Terminal A detects, while performing carrier sense, that a channel is temporarily busy due to transmission of the short-term signal by Terminal C, the time for transmission by Terminal C is shorter than the time for carrier sense, and thus Terminal A detects that the channel is idle after the end of transmission by Terminal C, and can transmit data.

After transmitting, in response, an ACK packet to Terminals A and C, the base station generates a polling trigger packet that has a priority index 2, and indicates Terminal B that is a next polling target.

Terminals D and E receive the polling trigger, and judge that the polling trigger is an interrupt trigger indicating the terminals themselves, and immediately transmit a short-term signal in an interrupt slot after the interrupt trigger. At this time, Terminals D and E each transmit a short-term signal at the same time, and thus a collision of the short-term signals occurs.

Terminal B performs the same processing as that performed by Terminal A, and transmits data.

The base station detects the collision of the short-term signals with a priority index 2 for which interruption is allowed and transmits an ACK packet to Terminal B, and thereafter specifies, with reference to the priority index management table, the terminal for which the same priority index has been assigned. For example, when the same priority index is set for Terminals E and D in the priority index management table, in order to avoid a collision of short-term signals, Terminal D is set as being a polling target, and a priority index for which interruption is allowed is set to 2, for a next polling trigger packet.

Accordingly, Terminal D receives the polling trigger indicating the terminal itself, and transmits data in accordance with the algorithm for transmission in the concentrated control period.

Further, Terminal E receives the polling trigger, and judges that the polling trigger is an interrupt trigger indicating the terminal itself, and immediately transmits a short-term signal in an interrupt slot after the interrupt trigger. In this way, since Terminals D and E perform transmission in different slots, respectively, a collision does not occur, and thus both terminals successfully perform transmission.

According to this configuration, when high priority data is generated in a terminal, it is determined, using the transmission period judgment algorithm, whether or not interrupt transmission of a short-term signal corresponding to the priority data is to be performed in the concentrated control period, based on the priority and allowable delay of the data. When it is determined that interrupt transmission is to be performed in the concentrated control period, a short-term signal is transmitted in an interrupt slot after a polling trigger including the same priority index as that of transmission data, using the algorithm for interrupt transmission in the concentrated control period. Although a terminal that transmits data in the concentrated control period in a normal manner performs carrier sense before transmission, the interrupt slot is shorter than the carrier sense slot, and thus it can be judged that a carrier is not used, and data can be transmitted.

Further, when a collision of short-term signals from interrupt terminals occurs, the base station specifies collision terminals from the collision priority index of the short-term signals that have collided, designates the collision priority index as a priority index for which interruption is allowed included in the polling trigger, and also designates the collision terminals as polling target terminals, thereby enabling high priority data to be preferentially transmitted.

As described above, according to the power-consumption-information collecting apparatus 1 in this scenario, a collision of short-term signals transmitted from the power meters 2 with a device control function is detected, and a management packet is generated using a priority index of the short-term signals that have collided, as a priority index included in a management packet for the period after the detection of the collision. Specifically, since the power-consumption-information collecting apparatus 1 cannot receive the short-term signals that have collided, the power-consumption-information collecting apparatus 1 generates a management packet including the priority index of the short-term signals that have collided, in order to receive the short-term signals again after the collision. Accordingly, even when high priority data is generated in the power meters 2 with a device control function, and a collision occurs when short-term signals for identifying the data are to be received, the short-term signals for identifying the high priority data that has collided can be received.

Next is a specific description of the effects that the power-consumption collecting system in the embodiment of the present invention achieves.

In a general household, there is often a problem that when many home appliances are utilized at the same time, power supplied to all the home appliances is interrupted due to breakers operating as a result of the allowable current of a master breaker being exceeded. However, in a house, there are about 50 to 60 home appliances, such as cooking home appliances, air-conditioners, illuminators, and information home appliances. With a method in which power consumption of all the home appliances is collected, and then the home appliances are controlled such that the allowable current (total power consumption limit value) of the master breaker will not be exceeded, it takes time to collect data, and thus a breaker may go down before controlling the home appliances.

In view of this, the power-consumption-information collecting apparatus 1 selects a home appliance whose power consumption is high, performs polling in the concentrated control period in order to enable power consumption data to be preferentially and reliably received, and collects, in the contention period, power consumption data of a low-power-consumption device and a device that is not operating other than the above device, thereby achieving a method for efficiently collecting data.

However, due to power consumption being collected from a selected terminal, when a home appliance whose power consumption is high suddenly operates, power consumption data thereof cannot be transmitted to the power-consumption-information collecting apparatus 1 with an allowable delay since that device is not on a polling list, which may result in total consumption power exceeding a limit value (a breaker goes down).

The following is a description of such a problem using a specific scenario.

For example, assume that home appliances including an electric pot, an electronic microwave oven, a television, two air-conditioners, and a plurality of low-power-consumption devices (eight illuminators, a fan, a radio, a personal computer, a game machine, a mobile phone charger, and the like) are operating inside a building at a certain time point.

Further, polling is performed in the concentrated control period, in order to preferentially collect data in real time from the electric pot, the electronic microwave oven, the television, and the two air-conditioners, which are home appliances that consume a lot of power. The low-power-consumption devices other than those transmit power consumption data in the contention period. Further, the permissible value of the master breaker of the building is 4000 W.

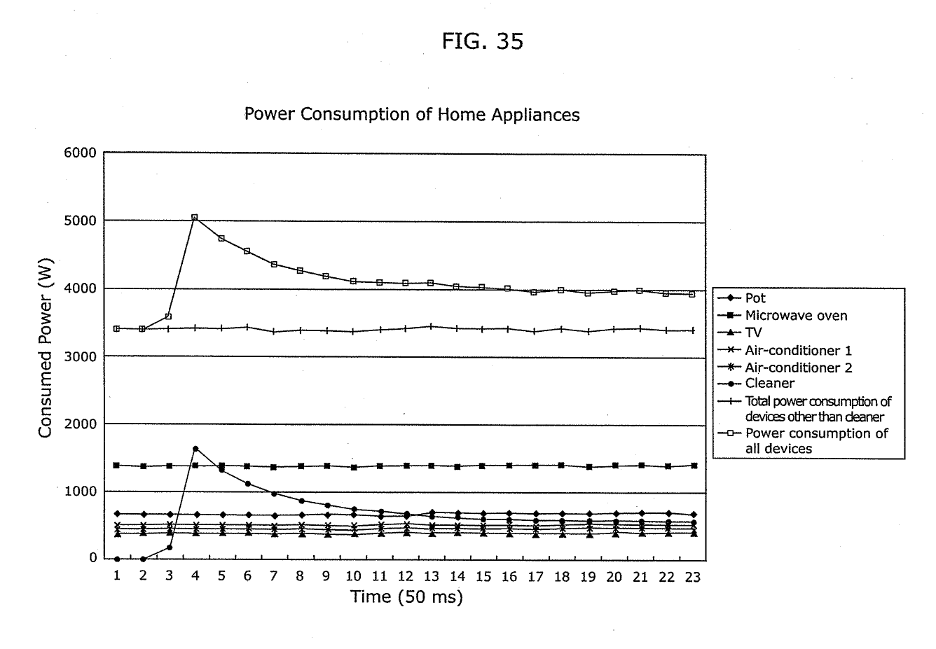

FIG. 35 shows power consumption of an electric pot, an electronic microwave oven, a television, and two air-conditioners.

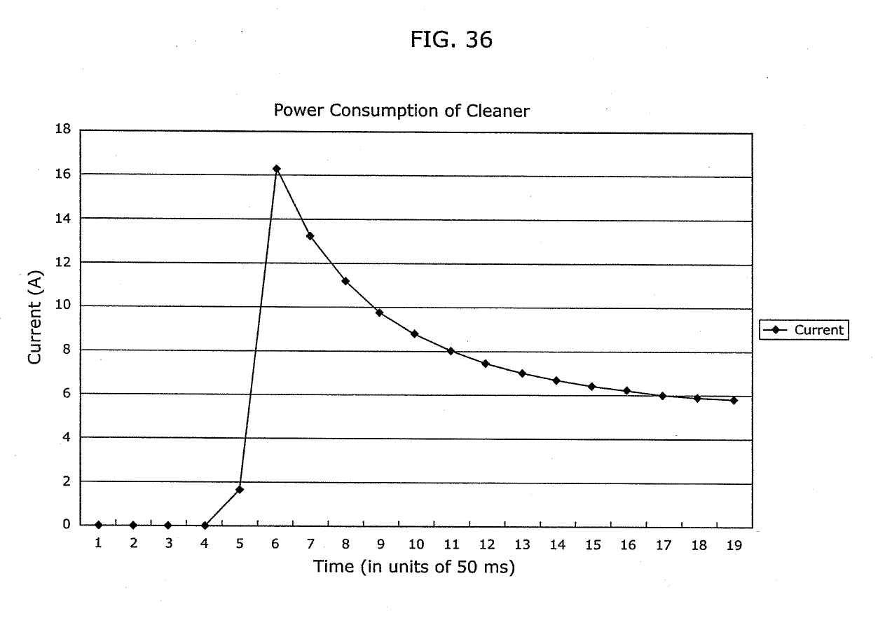

FIG. 36 shows power consumption of a cleaner.

The total power consumption of an electric pot, an electronic microwave oven, a television, and two air-conditioners is about 3500 W as shown in FIG. 35, and if power consumption of low-power-consumption devices is also considered, it can be seen that the total power consumption reaches near the limit value of 4000 W.

Suppose that a user starts using a cleaner at the next moment. Since the cleaner does not operate until the user uses the cleaner, the cleaner is not on the polling list, and if the user uses the cleaner, power consumption data of the cleaner will be transmitted in the contention period.

Further, as shown in FIG. 36, the power consumption characteristic (current) of the cleaner rises from 0 A to 2 A in 50 ms immediately after the start, and rises to 16 A in the next 50 ms. Specifically, the consumed electric current increases by 14 A or more in 50 ms.

Thus, in order to perform control such that total power consumption does not exceed the limit value, it is necessary to notify the power-consumption-information collecting apparatus 1 that the cleaner is to operate before power consumption of the cleaner suddenly rises. Specifically, this is a situation in which data regarding the cleaner needs to be transmitted within 50 ms (allowable delay).

With reference to FIG. 35, assume that parameters of the wireless system utilized by the home appliances 4 to 7 and the power-consumption-information collecting apparatus 1 are as follows.

Data transmission speed: 100 kilobits per second (kbps)

Packet size: fixed length of 127 bytes

Time slot: 2.4 milliseconds (ms)

Super frame: 64 time slots=154 ms

In the contention period, a plurality of home appliances communicate in a contending manner, and thus there is a possibility that data regarding the cleaner may not be transmitted to the power-consumption-information collecting apparatus 1, over a plurality of super frames. As shown in FIG. 35, if the cleaner operates, total power consumption exceeds the limit value for 600 ms or more, which will cause a breaker to go down. The present invention has been conceived to solve this problem.

Specifically, according to a communication apparatus (the power-consumption-information collecting apparatus 1) according to the present invention, a management packet including terminal identification information and a priority index is transmitted to communication terminal apparatuses (the power meters 2 with a device control function), and data is received from a communication terminal apparatus determined from the terminal identification information and the priority index. Specifically, the communication apparatus can receive data not only from a communication terminal apparatus assigned to transmit data, but also from a communication terminal apparatus that holds data with a predetermined priority. Accordingly, even if there is a communication terminal apparatus assigned to transmit data, when high priority data is generated in another communication terminal apparatus, that high priority data can be received from the other communication terminal apparatus.

Accordingly, for example, if data regarding a cleaner is set as being high priority data, data regarding the cleaner can be preferentially received, and a breaker can be prevented from going down due to total power consumption exceeding a limit value.

Further, data is preferentially received from a communication terminal apparatus that holds data with a priority indicated by a priority index, rather from a communication terminal apparatus indicated by terminal identification information. Specifically, the communication apparatus receives data from a communication terminal apparatus that holds data with a predetermined priority, instead of data from a communication terminal apparatus assigned to transmit data. Accordingly, even if there is a communication terminal apparatus assigned to transmit data, when high priority data is generated in another communication terminal apparatus, the high priority data can be received from the other communication terminal apparatus.

Further, a collision of data pieces transmitted from communication terminal apparatuses is detected, and a management packet is generated which includes a priority index of the data pieces that have collided, as a priority index included in a management packet for the period after the detection of the collision. Specifically, the communication apparatus cannot receive the data pieces that have collided, and thus in order to receive the data pieces again after the collision, a management packet including the priority index of the data pieces that have collided is generated. Accordingly, even when high priority data is generated in a communication terminal apparatus, and a collision occurs when the data is to be received, the high priority data that has collided can be received.

Further, after the collision of data pieces occurs, a management packet is generated such that the highest priority index to the collision priority index are repeated as a priority index included in a management packet. Specifically, when there is data with a priority higher than the priority of the data pieces that have collided, the higher priority data can be preferentially received. Accordingly, when data with a priority higher than the priority of the data pieces that have collided is generated in a communication terminal apparatus, the higher priority data can be received.

Further, a management packet is generated which includes terminal identification information pieces and priority indexes that are respectively corresponding to two or more periods. Accordingly, terminal identification information pieces and priority indexes corresponding to a plurality of periods determined in advance can be included in a management packet, and thus data to be received can be set with ease.

Further, a priority index according to the state of a device controlled by the communication terminal apparatus is determined, and a management packet including the determined priority index is generated. Specifically, a priority index is changed according to the state of the device controlled by the communication terminal apparatus by determining a specific priority index when the device is in a specific state, for instance. Accordingly, data in the case where the device controlled by the communication terminal apparatus is in a specific state can be preferentially received from a communication terminal apparatus.

According to a communication terminal apparatus (a power meter 2 with a device control function) according to the present invention, it is judged from the terminal identification information and the priority index which are included in the received management packet, whether or not the apparatus itself has obtained permission to transmit data, and that data is transmitted in a predetermined period. Specifically, the communication terminal apparatus can transmit data when the apparatus is a communication terminal apparatus assigned to transmit data or is a communication terminal apparatus that holds data with a predetermined priority. Accordingly, even when the communication terminal apparatus is not a communication terminal apparatus assigned to transmit data, when high priority data is generated, the communication terminal apparatus can transmit the high priority data.

Accordingly, for example, if data transmitted by a power meter 2 with a device control function connected to a cleaner is set as being high priority data, data regarding the cleaner can be preferentially transmitted, which can prevent a breaker from going down due to total power consumption exceeding a limit value.

Further, it is judged, from terminal identification information included in a management packet, whether or not the apparatus itself has obtained permission to transmit data, and also it is judged before transmission of data whether or not data is being transmitted from another communication terminal apparatus to the communication apparatus, and when it is judge that data is being transmitted from the other communication terminal apparatus, data is not transmitted. Specifically, even if the apparatus itself is a communication terminal apparatus assigned to transmit data, when data is being transmitted from the other communication terminal apparatus to the communication apparatus, data is not transmitted. Accordingly, even if the apparatus itself is a communication terminal apparatus assigned to transmit data, when high priority data is generated in another communication terminal apparatus, the other communication terminal apparatus is allowed to preferentially transmit the high priority data.

Further, a priority indicated by the priority index of data that the apparatus itself is to transmit is greater than or equal to the priority indicated by the priority index included in the management packet, and the apparatus transmits data when judging that the apparatus itself has obtained permission to transmit the data. Accordingly, when high priority data is generated in the apparatus itself, the apparatus can transmit the high priority data, even if there is another communication terminal apparatus assigned to transmit data.

Further, the priority index of data to be transmitted to the communication apparatus is determined according to the state of a device controlled by the apparatus itself, thereby judging whether or not the apparatus itself has obtained permission to transmit data. Specifically, a priority index is changed according to the state of the device controlled by the communication terminal apparatus, by determining a specific priority index when the device is in a specific state, for instance. Accordingly, data in the case where the device controlled by the communication terminal apparatus is in a specific state can be preferentially transmitted to the communication apparatus.

Although the above is a description of a communication apparatus and communication terminal apparatuses according to the present invention using the above embodiments, the present invention is not limited to these.

Specifically, the embodiments disclosed in this specification are to be considered in all respects as illustrative and not limiting. The scope of the present invention is indicated by the appended claims rather than by the foregoing description, and all modifications falling within the appended claims and the equivalency range of the appended claims are intended to be embraced therein.

Further, the present invention can be realized not only as such a communication apparatus or a communication terminal apparatus, but also as a communication system including the communication apparatus and the communication terminal apparatus. Further, the present invention can be realized as an integrated circuit including processing units that constitute the communication apparatus or the communication terminal apparatus, or as a method including processing performed by the processing units as steps. Furthermore, the present invention can be realized as a program that causes a computer to execute these steps, as a computer-readable recording medium such as a CD-ROM on which the program is recorded, or as information, data, or a signal that indicates the program. Then, the program, information, data, and signal may be distributed via a communication network, such as the Internet.

### INDUSTRIAL APPLICABILITY

A communication apparatus, a communication terminal apparatus, and a communication system according to the present invention are useful for a power-consumption collecting system and a data collecting system of a sensor network.

### REFERENCE SIGNS LIST

1 Power-consumption-information collecting apparatus (Communication apparatus)
2 Power meter with device control function (Communication terminal apparatus)
3 Building
4 to 7 Home appliance
8 Electrical outlet
100, 100a Management packet generation unit
101 Power measurement unit
102 Data holding unit
103 Power-consumption change amount calculation processing unit
105 Power-consumption collection determination transmission processing unit
106 Collection and control judgment processing unit
107 Home-appliance control transmission processing unit
108 Assigned-period priority index setting processing unit
110 Communication processing unit
111 Transmission unit
112 Receiving unit
200 Judgment Unit
201 Power measurement unit
202 Data holding unit
203 Received-frame analysis processing unit
205 Measured power-consumption value transmission processing unit
206 Home-appliance control unit
207 Transmission judgment unit
208 Packet generation unit
210 Communication processing unit
211, 211a Transmission unit
212 Receiving unit
303, 303a Transmission control unit
304 Backoff control unit
305 Transmission processing unit
401 Transmission-permission judgment unit
403 Concentrated-control-period transmission unit
501 Priority index management unit
501a, 501b Priority index management table
502 Priority index information holding unit

1. A communication apparatus that transmits and receives data to and from a plurality of communication terminal apparatuses, said communication apparatus comprising:
a management packet generation unit configured to generate a management packet including (i) terminal identification information indicating, among the communication terminal apparatuses, a communication terminal apparatus which is permitted to transmit data in a predetermined period, and (ii) a priority index indicating a priority of data permitted to be transmitted in the predetermined period;
a transmission unit configured to transmit the generated management packet to the communication terminal apparatuses; and
a receiving unit configured to receive data in the predetermined period from a communication terminal apparatus determined based on the terminal identification information and the priority index, from among the communication terminal apparatuses.

2. The communication apparatus according to claim 1,
wherein said management packet generation unit includes a priority index management unit configured to store priority index management information in which at least one priority index indicating a priority of terminal data held by one of the communication terminal apparatuses and at least one short-term signal for identifying the terminal data are associated with each other,
said receiving unit is configured to receive, when a first communication terminal apparatus indicated by the terminal identification information is permitted to transmit data in the predetermined period, and when a second communication terminal apparatus holds terminal data with a priority for which transmission in the predetermined period is permitted, a short-term signal for identifying the terminal data from the second communication terminal apparatus in a short-term period included in the predetermined period, the short-term period preceding a transmission period in which the first communication terminal apparatus transmits data, and
said transmission unit is configured to transmit a control signal to a communication terminal apparatus that is a control target and determined from terminal data identified using a short-term signal.

3. The communication apparatus according to claim 2,
wherein said priority index management unit is configured to store the priority index management information in which information indicating at least one of the communication terminal apparatuses that holds terminal data is further associated with the at least one priority index and the at least one short-term signal,
said management packet generation unit is configured to permit, with reference to the priority index management information, the second communication terminal apparatus to transmit data in a later period succeeding the predetermined period when said receiving unit receives a short-term signal, the second communication terminal apparatus being a communication terminal apparatus associated with the short-term signal,
said receiving unit is configured to receive terminal data identified using the short-term signal from the second communication terminal apparatus in the later period, and
said transmission unit is configured to transmit the control signal to a communication terminal apparatus that is a control target and determined from terminal data received by said receiving unit.

4. The communication apparatus according to claim 2,
wherein said priority index management unit is configured to store the priority index management information in which the terminal data is further associated with the at least one priority index and the at least one short-term signal, and
said transmission unit is configured to transmit the priority index management information to the communication terminal apparatuses, and transmit, when said receiving unit receives a short-term signal, the control signal to a communication terminal apparatus that is a control target and determined from terminal data associated with the short-term signal, with reference to the priority index management information.

5. The communication apparatus according claim 2,
wherein said priority index management unit is configured to calculate the priority index by subtracting, from a lowest priority index that is a greatest priority index number and indicates a lowest priority, a value obtained by multiplying, by a predetermined coefficient, an amount of change in power consumed when a device controlled by one of the communication terminal apparatuses performs an operation indicated by terminal data.

6. The communication apparatus according to claim 2,
wherein said receiving unit is configured to receive data from the first communication terminal apparatus in the predetermined period, after receiving the short-term signal from the second communication terminal apparatus in the short-term period.

7. The communication apparatus according to claim 2,
wherein said receiving unit is configured to detect a collision of short-term signals transmitted from the communication terminal apparatuses, and
said management packet generation unit is configured to obtain a collision priority index that is a priority index of the short-term signals that have collided, and generate a management packet for a period after the detection of the collision, the management packet including the obtained collision priority index as a priority index included in the management packet for the period after the detection of the collision.

8. The communication apparatus according to claim 1,
wherein when a first communication terminal apparatus indicated by the terminal identification information and a second communication terminal apparatus that holds data with a priority indicated by the priority index are permitted to transmit data in the predetermined period, said receiving unit is configured to receive data from the second communication terminal apparatus.

9. The communication apparatus according to claim 8,
wherein said receiving unit is configured to detect a collision of data pieces transmitted from the communication terminal apparatuses, and
said management packet generation unit is configured to obtain a collision priority index that is a priority index of the data pieces that have collided, and generate a management packet for a period after the detection of the collision, the management packet including the obtained collision priority index as a priority index included in the management packet for the period after the detection of the collision.

10. The communication apparatus according to claim 9,
wherein when the collision priority index is not a highest priority index indicating a highest priority, said management packet generation unit is configured to generate the management packet for the period after the detection of the collision such that the highest priority index to the collision priority index are repeated as the priority index included in the management packet for the period after the detection of the collision.

11. The communication apparatus according to claim 1,
wherein said management packet generation unit is configured to generate a management packet including terminal identification information pieces and priority indexes that respectively correspond to two or more periods.

12. The communication apparatus according to claim 1,
wherein said receiving unit is configured to receive, as data indicating a state of a device controlled by one of the communication terminal apparatuses, data including at least one of power consumption data, an amount of stored hot water, an amount of power generation, remaining battery power, and an operation mode of the device, and
said management packet generation unit is configured to determine a priority index according to the state of the device indicated by the data received by said receiving unit, and generate a management packet including the determined priority index.

13. A communication terminal apparatus that transmits and receives data to and from a communication apparatus, said communication terminal apparatus comprising:
a receiving unit configured to receive, from the communication apparatus, a management packet including (i) terminal identification information indicating a communication terminal apparatus which is permitted to transmit data in a predetermined period, and (ii) a priority index indicating a priority of data permitted to be transmitted in the predetermined period;
a judgment unit configured to judge from the terminal identification information and the priority index included in the received management packet, whether or not said communication terminal apparatus has obtained permission to transmit data; and
a transmission unit configured to transmit data in the predetermined period, when said judgment unit judges that said communication terminal apparatus has obtained permission to transmit the data.

14. The communication terminal apparatus according to claim 13,
wherein said judgment unit is configured to compare the priority index included in the management packet received by said receiving unit with a priority index of data that said communication terminal apparatus is to transmit, and judge that said communication terminal apparatus has obtained permission to transmit data, when a priority indicated by the priority index of the data that said communication terminal apparatus is to transmit is higher than or equal to a priority indicated by the priority index included in the management packet, and
said transmission unit is configured to transmit a short-term signal for identifying terminal data that is the data with the priority indicated by the priority index to the communication apparatus, when said judgment unit judges that said communication terminal apparatus has obtained permission to transmit data.

15. The communication terminal apparatus according to claim 14, further comprising
a priority index information holding unit configured to store priority index management information in which the terminal data, the priority index indicating the priority of the terminal data, and the short-term signal for identifying the terminal data are associated with one another,
wherein said receiving unit is configured to receive the priority index management information from the communication apparatus, and cause said priority index information holding unit to store the received priority index management information, and
said transmission unit is configured to transmit the short-term signal associated with the terminal data to the communication apparatus, with reference to the priority index management information.

16. The communication terminal apparatus according to claim 13,
wherein said judgment unit is configured to judge whether or not said communication terminal apparatus has obtained permission to transmit data, by comparing the terminal identification information included in the management packet received by said receiving unit with terminal identification information of said communication terminal apparatus, and
when said judgment unit judges that said communication terminal apparatus has obtained permission to transmit the data, said transmission unit is configured to (i) judge, before transmitting data, whether or not data is being transmitted from another communication terminal apparatus to the communication apparatus, (ii) avoid transmitting data when judging that data is being transmitted from the other communication terminal apparatus, and (iii) transmit data when judging that data is not being transmitted from the other communication terminal apparatus.

17. The communication terminal apparatus according to claim 13,
wherein said judgment unit is configured to compare the priority index included in the management packet received by said receiving unit with a priority index of data that said communication terminal apparatus is to transmit, and judge that said communication terminal apparatus has obtained permission to transmit data, when a priority indicated by the priority index of the data that said communication terminal apparatus is to transmit is higher than or equal to a priority indicated by the priority index included in the management packet, and
said transmission unit is configured to transmit data, when said judgment unit judges that said communication terminal apparatus has obtained permission to transmit the data.

18. The communication terminal apparatus according to claim 17,
wherein said judgment unit is configured to judge whether or not said communication terminal apparatus has obtained permission to transmit data, as a result of determination of a priority index of data to be transmitted to the communication apparatus according to a state of a device controlled by said communication terminal apparatus, the state being indicated by data including at least one of power consumption data, an amount of stored hot water, an amount of power generation, remaining battery power, and an operation mode of the device.

19. A communication system comprising a communication apparatus, and communication terminal apparatuses each of which transmits and receives data to and from said communication apparatus,
said communication apparatus including:
a management packet generation unit configured to generate a management packet including (i) terminal identification information indicating, among the communication terminal apparatuses, a communication terminal apparatus which is permitted to transmit data in a predetermined period, and (ii) a priority index indicating a priority of data permitted to be transmitted in the predetermined period;
a transmission unit configured to transmit the generated management packet to said communication terminal apparatuses; and
a receiving unit configured to receive data in the predetermined period from a communication terminal apparatus determined based on the terminal identification information and the priority index, from among said communication terminal apparatuses, and
each of said communication terminal apparatuses including:
a receiving unit configured to receive the management packet from said communication apparatus;
a judgment unit configured to judge, from the terminal identification information and the priority index included in the received management packet, whether or not said communication terminal apparatus has obtained permission to transmit data; and
a transmission unit configured to transmit data in the predetermined period, when said judgment unit judges that said communication terminal apparatus has obtained permission to transmit the data.

20. A communication method for a communication apparatus that transmits and receives data to and from a plurality of communication terminal apparatuses, said method comprising:
generating a management packet including (i) terminal identification information indicating, among the communication terminal apparatuses, a communication terminal apparatus which is permitted to transmit data in a predetermined period, and (ii) a priority index indicating a priority of data permitted to be transmitted in the predetermined period;
transmitting the generated management packet to the communication terminal apparatuses; and
receiving data in the predetermined period from a communication terminal apparatus determined based on the terminal identification information and the priority index, from among the communication terminal apparatuses.

21. A communication method for a communication terminal apparatus that transmits and receives data to and from a communication apparatus, said method comprising:
receiving, from the communication apparatus, a management packet including (i) terminal identification information indicating a communication terminal apparatus which is permitted to transmit data in a predetermined period, and (ii) a priority index indicating a priority of data permitted to be transmitted in the predetermined period;
judging from the terminal identification information and the priority index included in the received management packet, whether or not the communication terminal apparatus has obtained permission to transmit data; and
transmitting data in the predetermined period, when it is judged in said judging that the communication terminal apparatus has obtained permission to transmit the data.
